(19) United States
(12) Patent Application Publication
(10) Pub. No.: US 2026/0172275 A1
(43) Pub. Date: Jun. 18, 2026

(54) STORAGE MEDIUM, CONTROL METHOD, AND INFORMATION PROCESSING APPARATUS

(71) Applicant: CANON KABUSHIKI KAISHA, Tokyo (JP)

(72) Inventor: KENTO FURUKAWA, Kanagawa (JP)

(21) Appl. No.: 19/416,471

(22) Filed: Dec. 11, 2025

(30) Foreign Application Priority Data
Dec. 16, 2024 (JP) 2024-220342
Oct. 30, 2025 (JP) 2025-183645

(51) Int. Cl. H04L 12/18

(52) U.S. Cl. CPC H04L 12/1822

(57) ABSTRACT

A storage medium according to one aspect to the present disclosure is a storage medium that stores a computer program that executes a control method for controlling an information processing apparatus, in which the control method: displays a screen of an online meeting provided by a server on a display unit; receives, from the server, information indicating participation statuses with respect to the online meeting of a plurality of users who are scheduled to participate in the online meeting; and based on a determination being made that all of the plurality of users are participating in the online meeting based on the information that is received, further displays an object which had not been displayed on the screen and which is an object indicating that all of the plurality of users are participating in the online meeting.

### BACKGROUND

### Field of the Technology

The present disclosure relates to notification of information in an online meeting system.

### Description of the Related Art

Online meeting systems that are utilized to hold meetings online via communication networks such as the Internet are in widespread use. In an online meeting, because the attendees of the online meeting are located in different locations to each other, during the online meeting it is difficult to accurately ascertain who is in attendance at the online meeting. To address such issues, Japanese Patent Laid-Open No. 2007-025946 discloses technology for notifying users by email of the status of an online meeting in a case where there has been a change in the status of the online meeting, such as the start time or end time of the online meeting or when a user has joined or has left the online meeting.

However, in some cases there may be restrictions or a condition to be satisfied in order to start an online meeting, such as a prerequisite that a specific user is in attendance. There is a demand to improve online meeting systems so that notifications are sent that provide greater convenience to the attendees of online meetings.

### SUMMARY

The present disclosure provides a storage medium that stores a computer program that executes a control method for controlling an information processing apparatus, wherein the control method: displays a screen of an online meeting that is provided by a server on a display unit; receives, from the server, information indicating participation statuses with respect to the online meeting of a plurality of users who are scheduled to participate in the online meeting; and based on a determination being made that all of the plurality of users are participating in the online meeting based on the information that is received, further displays an object which had not been displayed on the screen and which is an object that indicates that all of the plurality of users are participating in the online meeting.

Features of the present disclosure will become apparent from the following description of embodiments with reference to the attached drawings. The following description of embodiments are described by way of example.

### BRIEF DESCRIPTION OF THE DRAWINGS

FIG. 1 is a view illustrating the configuration of an entire online meeting system;

FIG. 2 is a block diagram illustrating the hardware configuration of a user terminal;

FIG. 3 is a block diagram illustrating the hardware configuration of a server;

FIG. 4 is a block diagram illustrating the software configuration of an online meeting system 1;

FIG. 5 is a view illustrating an example of user information;

FIG. 6 is a view illustrating an example of meeting information;

FIG. 7 is a view illustrating an example of a scheduled attendees list;

FIG. 8 is a flowchart illustrating processing for updating an attendance status in a server;

FIG. 9 is a flowchart illustrating processing for updating and notifying an attendance status in a user terminal;

FIG. 10 is a view illustrating an example of a UI screen of an online meeting;

FIG. 11 is a view illustrating an example of an attendance notification screen that is displayed in a pop-up window;

FIG. 12 is a view illustrating an example of an attendance completion notification screen that is displayed in a pop-up window;

FIG. 13 is a view illustrating an example of an attendance notification screen of a second embodiment;

FIG. 14 is a flowchart illustrating processing for updating and notifying an attendance status of the second embodiment;

FIG. 15 is a view illustrating an example of an attendance completion notification screen of a third embodiment;

FIG. 16 is a flowchart illustrating processing for updating and notifying an attendance status of the third embodiment;

FIG. 17 is a view illustrating an example of an exit notification screen of a fourth embodiment;

FIG. 18 is a flowchart illustrating processing for updating and notifying an attendance status of the fourth embodiment;

FIG. 19 is a block diagram illustrating a software configuration of an online meeting system of a fifth embodiment; and

FIG. 20 is a sequence diagram illustrating the flow of processing executed in the online meeting system of the fifth embodiment.

### DESCRIPTION OF THE EMBODIMENTS

Hereinafter, embodiments for carrying out the present disclosure are described with reference to the accompanying drawings. Note that, the following embodiments are not intended to limit the scope of the appended claims, and not all combinations of features described in the embodiments are necessarily essential for the solution of the disclosure.

### First Embodiment

In online meetings, in some cases settings are made to indicate individuals whose attendance is definitely required and individuals whose attendance is optional. Therefore, in a first embodiment of the present disclosure, “required attendee” and “optional attendee” are set as categories of attendees in an online meeting. Further, there are situations where the attendance of all required attendees is a condition for starting an online meeting. In such a situation, it is necessary for the organizer or facilitator of the online meeting to decide the timing at which to start the online meeting after having ascertained which of the scheduled attendees are required attendees and whether or not the required attendees are in attendance. In the first embodiment, an online meeting system that is capable of handling such kind of situations is described.

### (System Configuration)

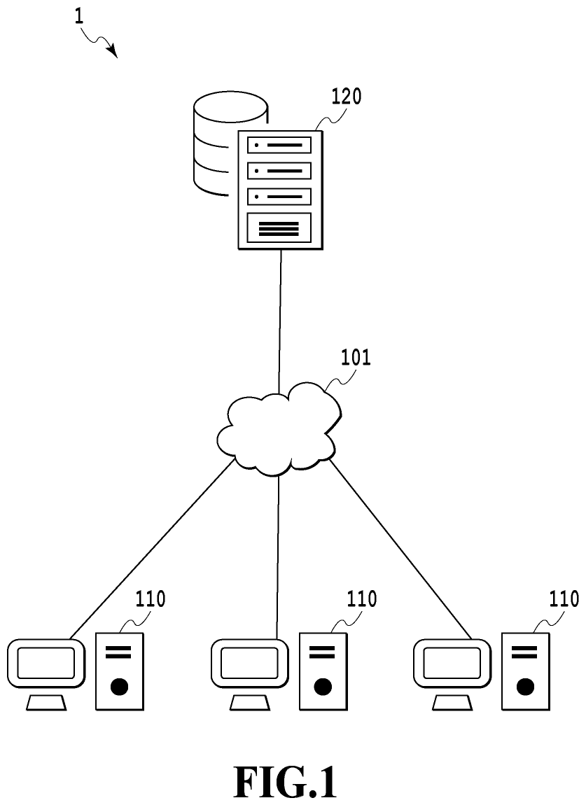

FIG. 1 is a view illustrating the system configuration of an online meeting system 1 according to the present disclosure. The online meeting system 1 includes a server 120 and user terminals 110, and the server 120 and the user terminals 110 are communicably connected via a communication line 101 such as a LAN, a WAN, or the Internet. The server 120 is a server device of the operator providing the services of the online meeting system 1, and is constituted by an information processing apparatus such as a computer. The user terminal 110 is a client in the online meeting system 1 that is a server-client system, and is an information processing apparatus used by a user utilizing an online meeting. The user terminal 110 is constituted by an information processing apparatus such as a PC (personal computer), a smartphone, or a tablet computer. The information processing apparatus is constituted by having at least one or a plurality of processors and one or a plurality of memories. Although in FIG. 1 an example is illustrated in which a plurality of the user terminals 110 are connected to a single server 120, the present disclosure is not limited to this example, and the server 120 may be constituted by a plurality of information processing apparatuses. Note that, since an online meeting is typically held between a plurality of users, a plurality of the user terminals 110 connect to the online meeting system 1 during an online meeting.

The user terminal 110 has a communication function for communicating with the server 120 via the communication line 101, and a browser function for displaying website data in a browsable manner. By using this communication function and this browser function, the user terminal 110 can access an online meeting room designated by link information such as a uniform resource locator (URL), and can display data of a meeting screen on a display unit of the user terminal 110. The term “online meeting room” refers to a website for an online meeting that is generated for each online meeting and is managed by the server 120. The user terminal 110 can invite other users to an online meeting by sharing the URL of the online meeting room with other user terminals.

In the present specification, the categories of users of an online meeting are “organizer” and “attendee”. Further, it is assumed that, in addition, the categories of “required attendee” and “optional attendee” are provided as categories of attendees. An organizer is a representative who is responsible for holding an online meeting, and can hold an online meeting by registering the necessary information on a website for registering the holding of an online meeting which is provided by the server 120. The information necessary to hold an online meeting is called “meeting information”. The meeting information includes the date and time for holding the meeting, the attendees, the categories of attendees (required attendee/optional attendee) and the like. A required attendee is an attendee whose attendance at the online meeting in question is designated as required by the organizer. An optional attendee is an attendee whose attendance at the online meeting in question is designated as optional by the organizer.

In a case where an organizer registers the holding of an online meeting, the server 120 performs pre-processing such as issuing a meeting ID and allocating an online meeting room. Further, as pre-processing, the server 120 also notifies the attendees of invitation information by email or by using a message function or the like of the online meeting system 1. The invitation information includes link information to the online meeting room of the online meeting.

### (Hardware Configuration)

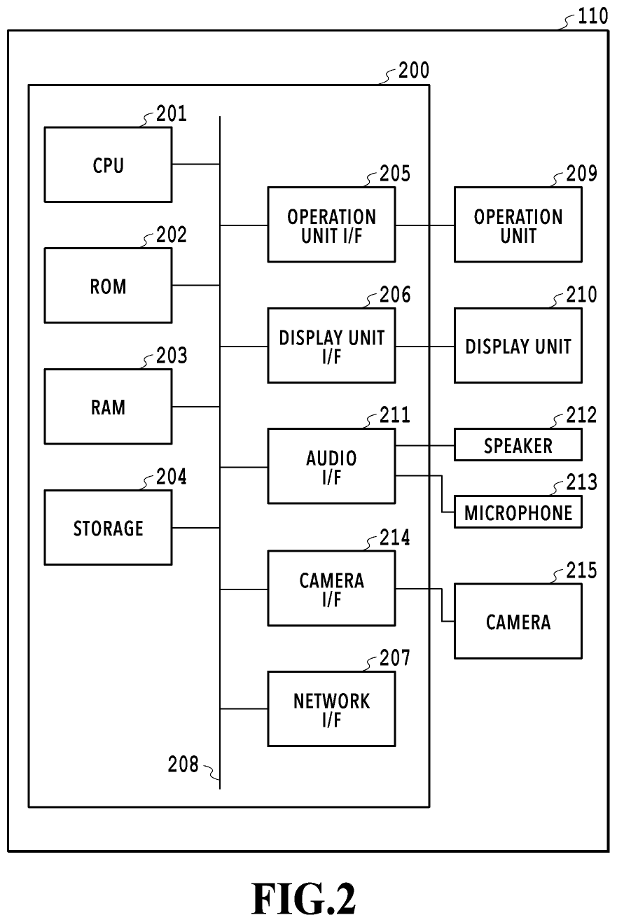

FIG. 2 is a block diagram illustrating the hardware configuration of the user terminal 110 that is utilized for an online meeting. As illustrated in FIG. 2, the user terminal 110 includes an information processing unit 200, an operation unit 209, a display unit 210, a speaker 212, a microphone 213, and a camera 215. The information processing unit 200 has a CPU 201, a ROM 202, a RAM 203, a storage 204, an operation unit I/F (interface) 205, a display unit I/F 206, a network I/F 207, an audio I/F 211, and a camera I/F 214. The respective components of the information processing unit 200 are connected by a system bus 208. Note that, although a typical PC configuration is illustrated as an example of the user terminal 110 in FIG. 2, components may be added or removed as appropriate depending on the device that is used as the user terminal 110. For example, a touch panel display having a configuration in which the operation unit 209 and the display unit 210 are integrated may be used.

The CPU 201 is a central processing unit, and controls each component of the information processing apparatus. The CPU 201 boots the OS (operating system) using a boot program stored in the ROM 202. On the OS, the CPU 201 loads an application program stored in the storage 204, loads the application program in the RAM, and executes various processes in accordance with the program. The RAM 203 is used as a work area for the CPU 201.

The storage 204 is a storage device such as a HDD (hard disk drive), an SSD (solid state drive), a flash memory, or the like, and stores application programs and data necessary for executing the application programs. The application programs include an application program for utilizing online meetings, which will be described later. Note that the storage 204 may also be an external storage area, such as cloud storage, that can be connected via the network I/F 207.

The operation unit I/F 205 is an interface with the operation unit 209, such as a touch panel, a keyboard, or a mouse. The operation unit I/F 205 sends information that is input by a user via the operation unit 209 to the CPU 201. The display unit I/F 206 includes a display control circuit, and outputs display information which has been output from the CPU 201, to the display unit 210. The display unit 210 is a display such as an LCD or organic EL display. The network I/F 207 is connected to the communication line 101, and performs operations for inputting and outputting information to and from the respective devices on the communication line 101. The audio I/F 211 converts audio that was input through the microphone 213 into audio data, and inputs the audio data to the CPU 201. In addition, the audio I/F 211 outputs audio data that was output from the CPU 201 to the speaker 212, to thereby output audio. The camera I/F 214 inputs imaging data that is input from the camera 215, to the CPU 201. The camera 215 has an image pickup device such as a CCD (charge coupled device) or a CMOS (complementary metal-oxide-semiconductor), and a lens, and inputs imaging data to the CPU 201.

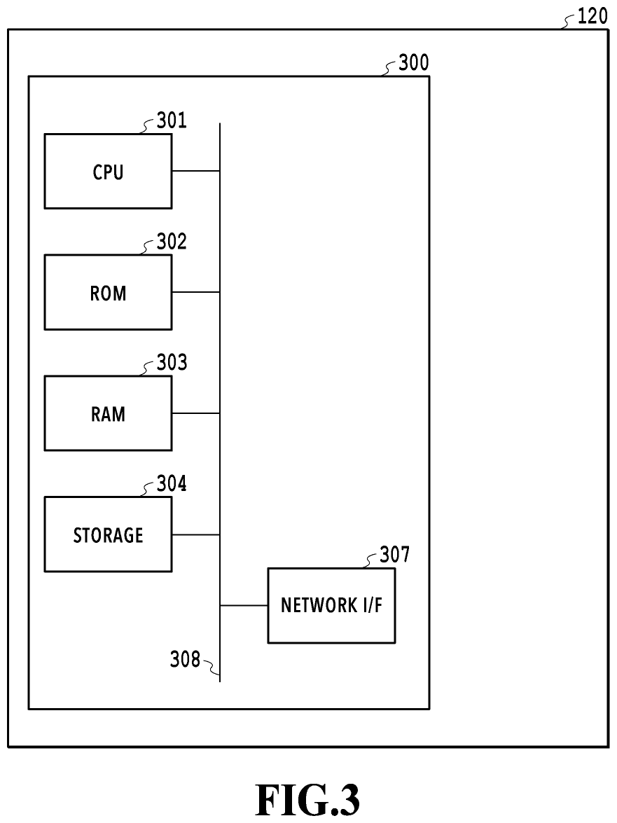

FIG. 3 is a block diagram illustrating the hardware configuration of an information processing apparatus utilized as the server 120. As illustrated in FIG. 3, the server 120 has an information processing unit 300. The information processing unit 300 has a CPU 301, a ROM 302, a RAM 303, a storage 304, and a network I/F 307 and the like, and each component is connected to a system bus 308. The CPU 301, the ROM 302, the RAM 303, the storage 304, and the network I/F 307 are similar to the CPU 201, the ROM 202, the RAM 203, the storage 204, and the network I/F 207 in the user terminal 110 illustrated in FIG. 2, and therefore a description of these components is omitted here.

Note that, the hardware configuration examples illustrated in FIG. 2 and FIG. 3 are examples of the respective hardware configurations, and components other than the components shown in FIG. 2 and FIG. 3 may also be included as appropriate. For example, the server 120 may have a configuration that includes an operation unit and a display unit.

In the present embodiment, it is assumed that various functions relating to online meetings that the server 120 of the online meeting system 1 provides are provided to the user terminal 110 as web services. In other words, the server 120 provides a UI (user interface) screen for an online meeting via a web browser of the user terminal 110. The server 120 performs operations to display various data on the user terminal 110 via the UI screen, and executes processing corresponding to various functions provided by the server 120 while accepting the input of data from the user terminal 110. Note that, the user terminal 110 may also be equipped with a dedicated application for conducting online meetings. By running the dedicated application, the user terminal 110 may execute processing corresponding to various functions of an online meeting tool with the server 120 while transmitting and receiving data to and from the server 120. Further, the present disclosure is not limited to these forms, and functions relating to online meetings may be implemented by an arbitrary method. Furthermore, the various hardware components constituting the server 120 may be virtual hardware resources that are cloud-based. In such case, the server 120 sends a request to execute a function to the corresponding hardware resource via the network I/F 207, and acquires the processing result via the network I/F 207.

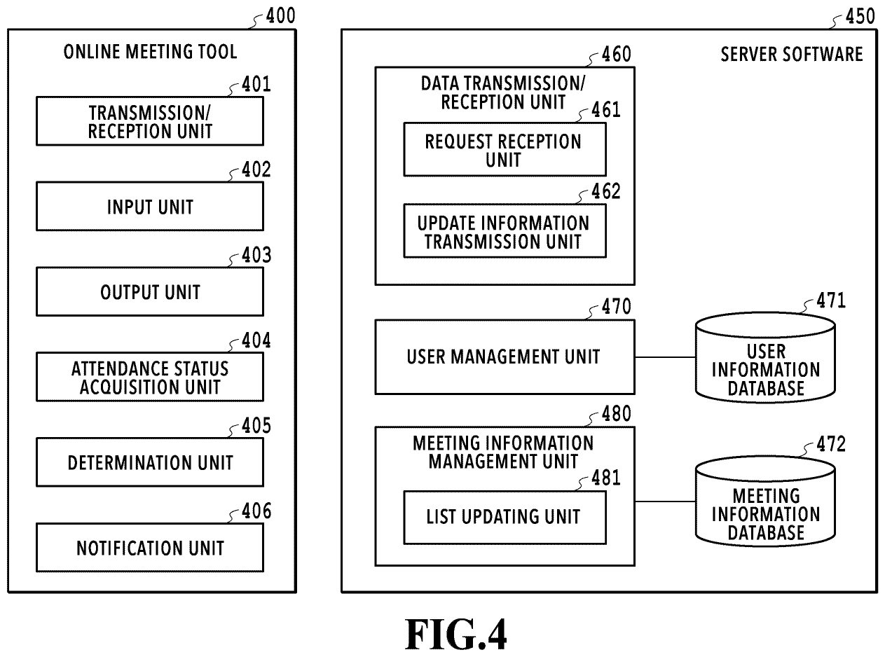

Next, the software configuration of the online meeting system 1 according to the present embodiment is described. FIG. 4 is a block diagram illustrating the software configuration of the online meeting system 1. As illustrated in FIG. 4, the online meeting system 1 includes an online meeting tool 400 and server software 450.

The online meeting tool 400 is an application program which the CPU 201 of the user terminal 110 executes. In the present specification, the online meeting tool 400 is stored in any one of the RAM 203, the storage 204, and the ROM 202 of the user terminal 110. The server software 450 is an application program which the CPU 301 of the server 120 executes. In the present specification, the server software 450 is stored in any storage device among the RAM 303, the storage 304, and the ROM 302 of the server 120.

### (Online Meeting Tool)

As illustrated in FIG. 4, the online meeting tool 400 has a transmission/reception unit 401, an input unit 402, an output unit 403, an attendance status acquisition unit 404, a determination unit 405, and a notification unit 406. The CPU 201 of the user terminal 110 calls a program of the online meeting tool 400 stored in the storage 204, and the CPU 201 executes processing in accordance with the program. By this means, the CPU 201 causes the user terminal 110 to function as the transmission/reception unit 401, the input unit 402, the output unit 403, the attendance status acquisition unit 404, the determination unit 405, and the notification unit 406.

The transmission/reception unit 401 carries out communication with the server 120 via the communication line 101, and transmits and receives various kinds of data including audio data, imaging data, display data, text data, instruction data, and meeting information for an online meeting to and from the server 120. The meeting information will be described later. Specifically, the transmission/reception unit 401 transmits to the server 120 instructions that are input from the input unit 402, requests relating to attendance, exit, and absence with respect to the online meeting, and text data, audio data, imaging data and other various kinds of data that are input with respect to the online meeting. At such time, the transmission/reception unit 401 adds identification information such as a meeting ID or a user ID to the data to be transmitted, and transmits the data. In addition, the transmission/reception unit 401 receives data transmitted from the server 120, and outputs the data to the output unit 403 or the attendance status acquisition unit 404. Specifically, in a case where the transmission/reception unit 401 receives display data for the meeting screen or audio data or text data for the online meeting from the server 120, the transmission/reception unit 401 outputs the received data to the output unit 403. Further, in a case where the transmission/reception unit 401 receives a scheduled attendees list 700 and update information for the scheduled attendees list 700 from the server 120, the transmission/reception unit 401 outputs the received data to the attendance status acquisition unit 404.

The input unit 402 accepts instructions and text data which are input by the user via the operation unit 209 of the user terminal 110. Further, the input unit 402 accepts audio data of the user which is input via the microphone 213 of the user terminal 110, and imaging data which was picked up by the camera 215 of the user terminal 110. The input unit 402 sends various kinds of data such as accepted instructions, requests, text data, audio data, and imaging data to the transmission/reception unit 401.

The output unit 403 displays a meeting screen, which is a UI screen for an online meeting, and a notification screen that includes notification information on the display unit 210 of the user terminal 110. The output unit 403 is also referred to as a display control unit. The meeting screen includes imaging data of the user and other attendees at the online meeting, shared screen data, and the like. The notification screen includes notification information relating to the attendance statuses of required attendees at the online meeting. The notification information is generated by the notification unit 406. The meeting screen and notification screen will be described later. Further, the output unit 403 outputs audio data of the online meeting from the speaker 212. The output unit 403 generates display data based on the meeting information and other various kinds of information, and outputs the display data to the display unit 210 for display.

The attendance status acquisition unit 404 acquires, from the server 120, attendance statuses with respect to the online meeting of the scheduled attendees including required attendees (first users) whose attendance at the online meeting is required and optional attendees (second users) whose attendance at the online meeting is optional. The attendance status acquisition unit 404 acquires the aforementioned attendance statuses while the online meeting is in progress. The attendance status is managed as the scheduled attendees list 700 in a meeting information management unit 480 of the server 120. In a case where there is a change in the attendance status, such as a change from “not attending” to “attending”, information indicating the change is transmitted to the user terminal 110 of each attendee from a data transmission/reception unit 460 (update information transmission unit 462) of the server 120.

The determination unit 405 determines whether or not a required attendee is attending the online meeting based on the attendance status of the required attendee among the attendance statuses which the attendance status acquisition unit 404 acquired. Specifically, the determination unit 405 determines whether or not the attendance status of the required attendee has changed to “attending”. Further, the determination unit 405 determines whether or not all required attendees are attending the online meeting based on the attendance statuses of the required attendees among the attendance statuses which the attendance status acquisition unit 404 acquired. Specifically, the determination unit 405 determines whether or not the attendance statuses of all of the required attendees have changed to “attending”. The determination unit 405 passes the determination result to the notification unit 406.

The notification unit 406 generates notification information based on the determination result determined by the determination unit 405 based on the attendance statuses of the required attendees that the attendance status acquisition unit 404 acquired. In a case where it was determined by the determination unit 405 that the attendance status of a required attendee was updated to “attending”, the notification unit 406 generates notification information (first notification information) to the effect that the required attendee is attending the online meeting. In a case where it is determined by the determination unit 405 that the attendance status of all of the required attendees is “attending”, the notification unit 406 generates notification information (second notification information) to the effect that all of the required attendees are attending the online meeting. The notification unit 406 immediately transmits the generated notification information to the output unit 403.

The output unit 403 acquires notification information relating to the attendance status of a first user that was generated by the notification unit 406, and immediately displays the notification information on the display unit 210. Specifically, in a case where the output unit 403 acquires notification information to the effect that a required attendee is attending the online meeting, the output unit 403 displays an attendance notification screen. Further, in a case where the output unit 403 acquires notification information to the effect that all required attendees are attending the online meeting, the output unit 403 displays an attendance completion notification screen.

Preferably, the output unit 403 causes notification information relating to the attendance statuses of first users to be displayed on the display unit 210 separately from the information indicating the attendance statuses of the scheduled attendees. For example, the output unit 403 causes a notification screen including notification information relating to the attendance statuses of first users to be displayed in the front of the meeting screen of the online meeting. It is assumed that at such time the attendance statuses of all of the scheduled attendees are displayed on the meeting screen. In the present specification, a display form in which a separate screen (notification screen) is displayed in the front of the main screen (meeting screen) is referred to as a “pop-up display”.

Note that, the method of notification is not limited to a pop-up display on the meeting screen, and may be a display in an information region of the meeting screen, or the display of an icon indicating the attendance of a required attendee or an icon indicating the attendance of all required attendees. Further, the method of notification may be an immediate notification using a chat function that the online meeting tool 400 has, or a notification issued by sending an email or the like. The details of the attendance notification screen and the attendance completion notification screen are described later.

The attendance status acquisition unit 404 acquires update information relating to attendance statuses that is transmitted from the update information transmission unit 462 of the server 120. The update information is transmitted to the user terminals 110 of the attendees of the online meeting each time the attendance status of an individual scheduled attendee is updated in the server 120. The term “attendee of the online meeting” refers to a user who is a scheduled attendee at the online meeting and whose attendance status has been updated to “attending”. The notification unit 406 generates notification information in real time each time the attendance status acquisition unit 404 acquires update information, and outputs the notification information from the output unit 403. By this means, the attendance of required attendees or the timing at which there is full attendance, which can serve as a criterion for determining the timing at which to start the online meeting, can be immediately notified, and can thus be useful for proceeding with the online meeting.

Note that, a notification to the effect that a required attendee is attending the online meeting, and a notification to the effect that all required attendees are attending may be executed on the user terminals 110 of all attendees of the online meeting, or execution of the notification may be limited to the user terminal 110 used by a specific user, such as an organizer or a facilitator of the online meeting. It is assumed that the specific user is a user designated by the organizer of the online meeting or by the scheduled attendees.

### (Server Software)

As illustrated in FIG. 4, the server software 450 has the data transmission/reception unit 460, a user management unit 470, the meeting information management unit 480, a user information database 471, and a meeting information database 472. The data transmission/reception unit 460 includes a request reception unit 461 and the update information transmission unit 462. The meeting information management unit 480 includes a list updating unit 481. The CPU 301 of the server 120 calls a program of the server software 450 stored in the storage 304, and the CPU 301 executes processing in accordance with the program to thereby cause the server 120 to function as each unit of the server software 450 illustrated in FIG. 4.

The data transmission/reception unit 460 carries out communication via the communication line 101 with the user terminals 110 that the users of the online meeting system 1 use, and transmits and receives various data including audio data, imaging data, display data, text data, and meeting information of the online meeting.

The request reception unit 461 receives information relating to a change in attendance status transmitted from the user terminal 110, and transmits the information to the meeting information management unit 480. The information relating to a change in attendance status is any one of an attendance request with respect to the online meeting, an exit request with respect to the online meeting, and an absence request with respect to the online meeting. An attendance request is transmitted to the server 120 in a case where the URL of the online meeting room is accessed from the user terminal 110. An exit request is transmitted to the server 120 in a case where a user performs an operation with respect to an exit button on a meeting screen displayed on the user terminal 110 during the online meeting. An absence request with respect to the online meeting is transmitted from the user terminal 110 to the server 120 via a predetermined UI screen prior to the start time of the online meeting or while the online meeting is in progress.

The update information transmission unit 462 acquires the scheduled attendees list 700 that is managed by the meeting information management unit 480 and update information for the scheduled attendees list 700 from the meeting information management unit 480, and transmits the acquired scheduled attendees list 700 and update information to the user terminals 110 of the attendees of the online meeting in question. The scheduled attendees list 700 will be described later.

The user management unit 470 manages information relating to the users that use the online meeting system 1. Hereinafter, information relating to the users that use the online meeting system 1 will be referred to as user information. The user information is stored in the user information database 471, and is saved in the storage 204. The user information will be described later.

The meeting information management unit 480 executes management processing for online meetings, including accepting the holding of an online meeting, setting an online meeting room, managing the schedule of the online meeting, and managing the attendance for the online meeting. For example, on a website that the server 120 provides or on a predetermined setting screen provided by the online meeting tool 400, the meeting information management unit 480 accepts a request to hold an online meeting that is made by a user who is the organizer. At such time, the meeting information management unit 480 issues a meeting ID and generates a URL for the online meeting room. Further, the meeting information management unit 480 accepts settings related to the online meeting, including information such as the start time, end time, meeting name, and scheduled attendees for the online meeting. The meeting information management unit 480 generates meeting information based on the accepted settings, and stores the generated meeting information in the meeting information database 472, and saves the meeting information in the storage 304. The meeting information includes information such as the meeting ID, start time, end time, meeting name, online meeting room, and scheduled attendees for the online meeting. The meeting information will be described later.

The list updating unit 481 generates the scheduled attendees list 700 that is information relating to the scheduled attendees of the online meeting. In addition, the list updating unit 481 updates the scheduled attendees list 700 in accordance with attendance requests, exit requests, and absence requests that are transmitted from the user terminals 110. Specifically, the list updating unit 481 updates the scheduled attendees list 700 based on attendance requests, exit requests, and absence requests which the request reception unit 461 received. Further, each time an update is made, the list updating unit 481 transmits the update information for the scheduled attendees list 700 to the user terminals 110 of the attendees of the online meeting. The scheduled attendees list 700 will be described later.

### (User Information Database)

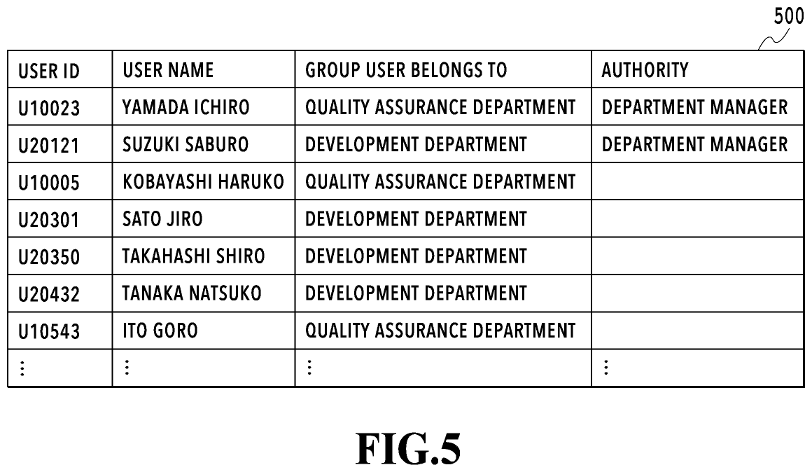

FIG. 5 is a view illustrating an example of user information 500 that is stored in the user information database 471. The user information 500 is information relating to users that utilize the online meeting system 1. For example, registration of the user information 500 is accepted in a case where user registration is accepted from a website provided by the server 120, or in a case where the online meeting tool is installed. As illustrated in FIG. 5, the user information 500 includes a user ID, a user name, a group the user belongs to, and information relating to the authority of the user or the like. The user name may be the name of the user or may be an account name that is arbitrarily set. The group the user belongs to is registered in association with the user ID in a case where the user belongs to a group of some kind. For example, the name of a company department or the like is registered as the value of the group the user belongs to. A group the user belongs to does not necessarily have to be registered. The authority is registered in association with the user ID in a case where the user has some authority. For example, if the user is a manager of the group the user belongs to, a job title or the like is registered as the value for the authority. The authority does not necessarily have to be registered.

### (Meeting Information Database)

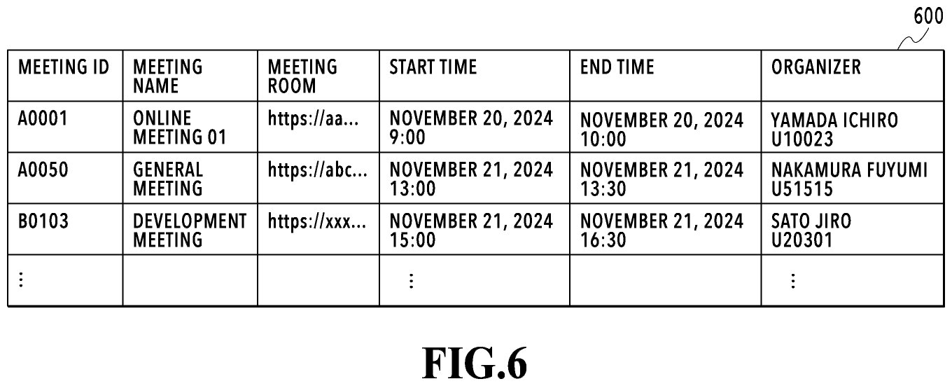

FIG. 6 is a view illustrating an example of meeting information 600 that is stored in the meeting information database 472. The meeting information 600 is information relating to an online meeting to be held using the online meeting system 1. For example, in a case where an application to hold an online meeting is made by a user who is the organizer from a website that the server 120 provides, the server 120 issues a meeting ID and generates a new meeting information 600 record. As illustrated in FIG. 6, the meeting information 600 includes information such as the meeting ID, meeting name, online meeting room, start time, end time, and organizer. The meeting ID is information that identifies the online meeting which is issued by the server 120. A meeting name that is set by the organizer or a meeting name that is automatically set by the server 120 is stored as the meeting name. Times that are set by the organizer are stored as the start time and the end time. The user ID or user name of the user who is the organizer is stored as the organizer.

### (Scheduled Attendees List)

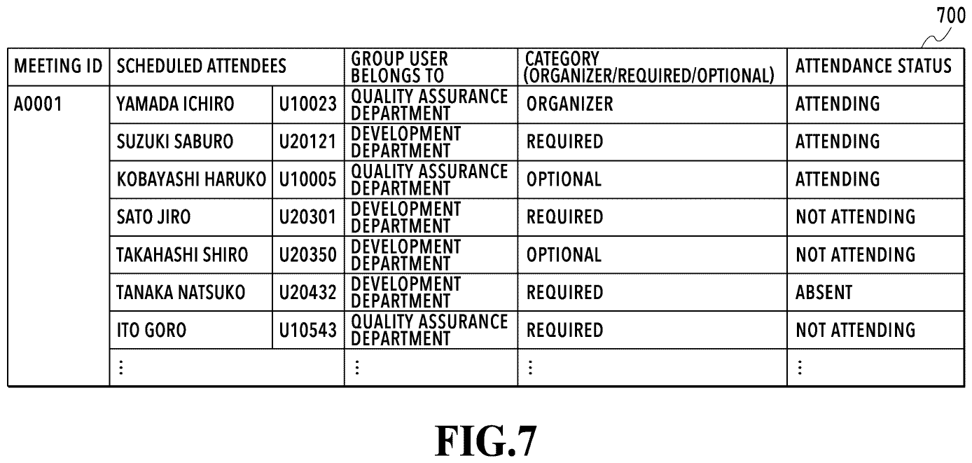

FIG. 7 is a view illustrating an example of the scheduled attendees list 700 that is managed by the meeting information management unit 480 of the server 120. The scheduled attendees list 700 is generated for each online meeting, and consists of information relating to users who are registered as scheduled attendees of the online meeting, and is managed in association with a meeting ID. As illustrated in FIG. 7, the scheduled attendees list 700 includes a meeting ID, scheduled attendees, groups the users belong to, categories, and attendance status. The meeting ID is the meeting ID registered in the meeting information 600. For each scheduled attendee, a user ID or a user name or the like as well as identification information of the user are stored. The scheduled attendees are users designated by the organizer, and together with accepting the holding of an online meeting, the server 120 also accepts the registration of scheduled attendees. At such time, the server 120 also accepts the setting of the category of each scheduled attendee. The category is either one of “required attendee” and “optional attendee”. Note that, among the required attendees, the organizer of the relevant online meeting may be registered as “organizer”. The attendance status shows the attendance status with respect to the online meeting of the users (scheduled attendees) included in the scheduled attendees list 700, and the status information that is registered is one of “attending”, “not attending”, and “absent”. Note that, “not attending” is set as the initial value for the attendance status. In a case where a user attends (also referred to as “participates”, “enters the online meeting room”, or the like) the online meeting in question, the attendance status of the relevant user is updated from “not attending” to “attending”. Further, in a case where a user who had been attending an online meeting exits the online meeting, the attendance status of the relevant user is updated from “attending” to “not attending”. In a case where a user applies in advance to be absent (absence request) from a target online meeting, the attendance status of the relevant user is updated from “not attending” to “absent”. In this way, the attendance status is updated as required during the online meeting and before the online meeting. These updates to the attendance statuses are performed by the meeting information management unit 480. The scheduled attendees list 700 and the update information for the scheduled attendees list 700 are shared in real time with the user terminals 110 of the attendees of the online meeting.

### (Processing of Server)

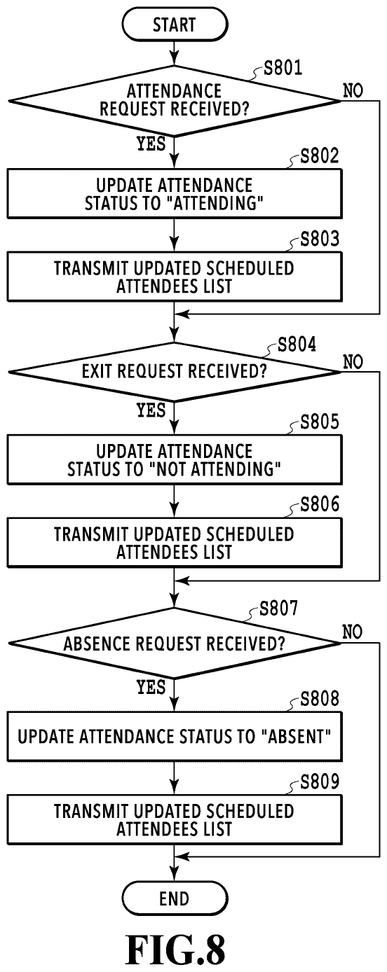

Next, processing that the server 120 executes is described with reference to FIG. 8. FIG. 8 is a flowchart illustrating the flow of processing relating to updating of the attendance statuses of an online meeting. The processing illustrated in the flowchart of FIG. 8 is described in a program stored in the storage 304. The program is called by the CPU 301 of the server 120, loaded in the RAM 302, and executed by the CPU 301. After the server 120 is started up, the server 120 starts the processing shown in the present flowchart. In the following description, the symbol “S” represents “step”.

The request reception unit 461 of the server 120 waits for a request from the user terminal 110. In S801, in a case where the request reception unit 461 of the server 120 receives an attendance request from the user terminal 110, the process proceeds to S802. If an attendance request is not received, the process proceeds to S804. Note that, it is assumed that a meeting ID and a user ID are added to the attendance request.

In S802, the request reception unit 461 transmits the attendance request and the added information to the list updating unit 481. The list updating unit 481 identifies the scheduled attendees list 700 corresponding to the meeting ID included with the attendance request, and updates the attendance status associated with the corresponding user ID in the identified scheduled attendees list 700 from “not attending” to “attending”. The list updating unit 481 generates update information for the scheduled attendees list 700, and transmits the update information to the update information transmission unit 462. The update information may be the entire scheduled attendees list 700 after updating, or may be only the information for the updated portion. Further, it is assumed that the meeting ID of the scheduled attendees list 700 that was updated and information indicating the transmission destination of the update information are added to the update information. It is assumed that the transmission destination of the update information is the user terminals 110 of all the attendees of the online meeting that are identified by the meeting ID included with the update information.

In S803, the update information transmission unit 462 transmits the update information to the user terminals 110 that are the transmission destination. Thereafter, the process proceeds to S804.

In S804, if the request reception unit 461 of the server 120 receives an exit request from the user terminal 110, the process proceeds to S805. If an exit request is not received, the process proceeds to S807. Note that, it is assumed that a meeting ID and a user ID are added to the exit request.

In S805, the request reception unit 461 transmits the exit request and the added information to the list updating unit 481. The list updating unit 481 identifies the scheduled attendees list 700 corresponding to the meeting ID included with the exit request, and updates the attendance status associated with the corresponding user ID in the identified scheduled attendees list 700 to “not attending”. The list updating unit 481 generates update information for the scheduled attendees list 700, and transmits the update information to the update information transmission unit 462. The update information may be the entire scheduled attendees list 700 after updating, or may be only the information for the updated portion. Further, it is assumed that the meeting ID of the scheduled attendees list 700 that was updated and information indicating the transmission destination of the update information are added to the update information. It is assumed that the transmission destination of the update information is the user terminals 110 of all the attendees of the online meeting that are identified by the meeting ID included with the update information.

In S806, the update information transmission unit 462 transmits the update information to the user terminals 110 that are the transmission destination. Thereafter, the process proceeds to S807.

In S807, if the request reception unit 461 of the server 120 receives an absence request from the user terminal 110, the process proceeds to S808. If an absence request is not received, the present flowchart ends. Note that, it is assumed that a meeting ID and a user ID are added to the absence request.

In S808, the request reception unit 461 transmits the absence request and the added information to the list updating unit 481. The list updating unit 481 identifies the scheduled attendees list 700 corresponding to the meeting ID included with the absence request, and updates the attendance status associated with the corresponding user ID in the identified scheduled attendees list 700 to “absent”. The list updating unit 481 generates update information for the scheduled attendees list 700, and transmits the update information to the update information transmission unit 462. The update information may be the entire scheduled attendees list 700 after updating, or may be only the information for the updated portion. Further, it is assumed that the meeting ID of the scheduled attendees list 700 that was updated and information indicating the transmission destination of the update information are added to the update information. It is assumed that the transmission destination of the update information is the user terminals 110 of all the attendees of the online meeting that are identified by the meeting ID included in the update information.

In S809, the update information transmission unit 462 transmits the update information to the user terminals 110 that are specified as the transmission destination. Note that, a configuration may also be adopted so that, if an absence request is received at a timing that is prior to the start date and time of the online meeting, the processing in S809 is not performed. After the processing up to S809 is completed, the present flowchart ends.

### (Processing of User Terminal)

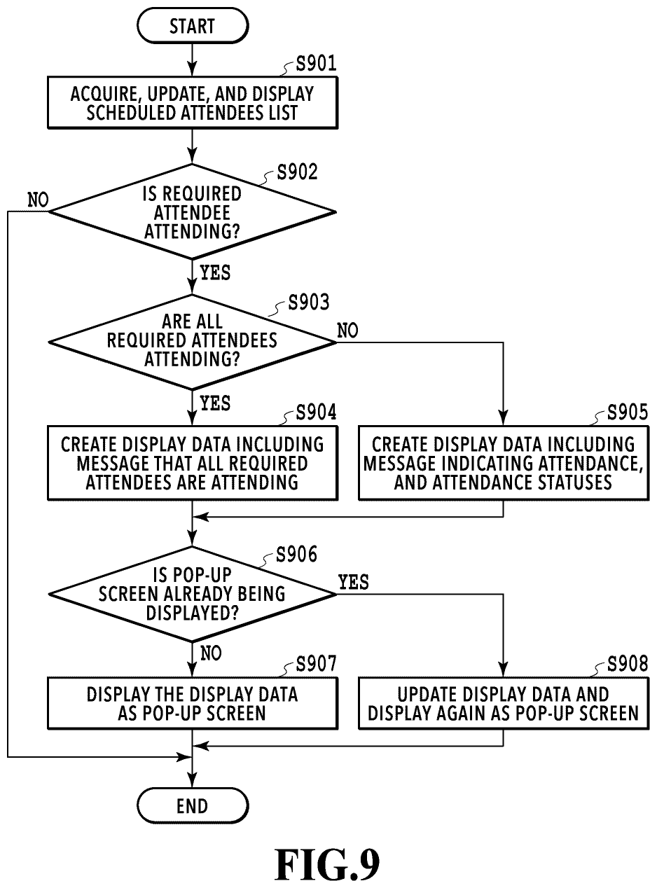

Next, processing that the user terminals 110 of the attendees of an online meeting execute is described with reference to FIG. 9. FIG. 9 is a flowchart illustrating the flow of processing relating to updating and notification of an attendance status for an online meeting. The processing illustrated in the flowchart of FIG. 9 is described in a program of the online meeting tool 400. The program is called by the CPU 201 of the user terminal 110, loaded in the RAM 203, and executed by the CPU 201. After the time when the user can enter the online meeting room has arrived and the user performs an operation to attend the online meeting, the CPU 201 of the user terminal 110 accesses the online meeting room specified by the URL and requests to attend the online meeting. In a case where a response to the attendance request is received from the server 120 and attendance is confirmed, the processing of the flowchart shown in FIG. 9 is started. Note that it is assumed that the time when the user can enter the online meeting room includes the time period from the start time to the end time of the online meeting and also a predetermined preparation time period prior to the start time.

In S901, the transmission/reception unit 401 of the user terminal 110 acquires the scheduled attendees list 700. The scheduled attendees list 700 is transmitted from the server 120 as a response from the server 120 to an attendance request with respect to the online meeting, along with display data for the UI screen (meeting screen) of the online meeting. As illustrated in FIG. 7, the scheduled attendees list 700 includes the categories of the scheduled attendees (organizer, required attendee, and optional attendee) of the online meeting, and information regarding the attendance status of each scheduled attendee. The transmission/reception unit 401 sends the acquired scheduled attendees list 700 to the attendance status acquisition unit 404. Upon acquiring the scheduled attendees list 700, the attendance status acquisition unit 404 stores the scheduled attendees list 700 in the RAM 203. The output unit 403 acquires information regarding the attendance statuses of the scheduled attendees from the scheduled attendees list 700, and displays the attendance statuses on the meeting screen.

Further, update information for the scheduled attendees list 700 is transmitted as required from the server 120. If the transmission/reception unit 401 of the user terminal 110 acquires update information for the scheduled attendees list 700, the transmission/reception unit 401 sends the update information to the attendance status acquisition unit 404. The attendance status acquisition unit 404 updates the attendance statuses of the scheduled attendees list 700 stored in the RAM 203 based on the update information. Further, if an attendance status in the scheduled attendees list 700 stored in the RAM 203 has been updated, the output unit 403 acquires the updated attendance status information and reflects the updated information on the meeting screen. In addition, in a case where notification information is generated by the notification unit 406 based on update information, the output unit 403 displays a notification screen including the notification information in a pop-up window.

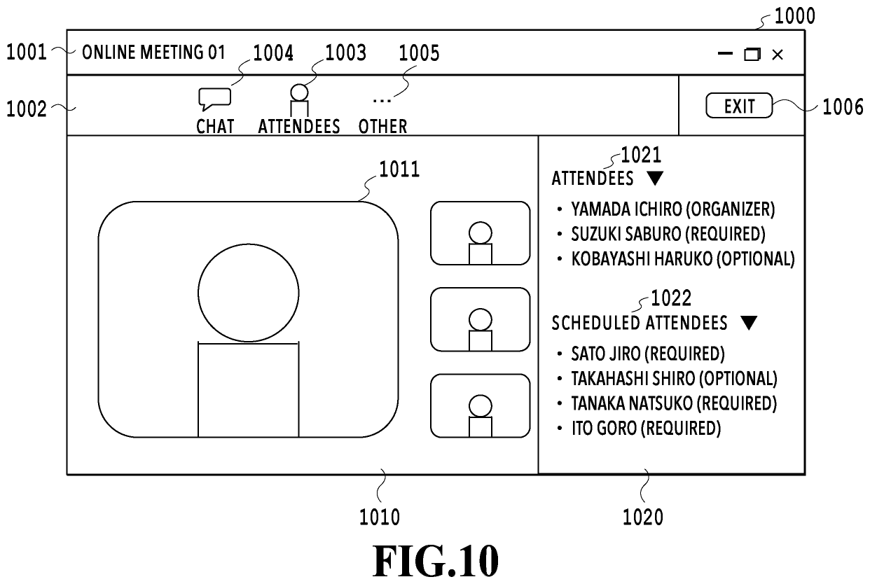

FIG. 10 is a view illustrating an example of a meeting screen 1000 that is a UI screen for the online meeting that is displayed on the display unit 210 of the user terminal 110. Upon acquiring display data of the meeting screen 1000 or data relating to the online meeting from the server 120, the output unit 403 of the online meeting tool 400 generates the meeting screen 1000 based on the acquired data and displays the meeting screen 1000 on the display unit 210.

In the example in FIG. 10, the meeting screen 1000 includes a menu bar 1002, a user image region 1010, an information region 1020, and an exit button 1006. A meeting name 1001 or a meeting ID, such as “Online Meeting 01”, is displayed in the upper left part of the meeting screen 1000. Icons for executing various functions included in the online meeting tool 400 are displayed in the menu bar 1002. For example, an icon 1004 for a chat function, an icon 1003 for an attendee display function, and an icon 1005 for other functions are included in the menu bar 1002. In a case where the icon 1003 for the attendee display function is selected by a user, the output unit 403 displays an attendees list 1021 and a scheduled attendees list 1022 in the information region 1020. Note that, the output unit 403 generates and displays the attendees list 1021 and the scheduled attendees list 1022 based on the acquired scheduled attendees list 700 and update information for the scheduled attendees list 700.

In the attendees list 1021, the user names of users whose attendance status for the online meeting is “attending” are displayed as a list. In the scheduled attendees list 1022, the user names of users whose attendance status is “not attending” among the users registered as scheduled attendees are displayed as a list. Further, in the attendees list 1021 and the scheduled attendees list 1022, the category of the user (organizer, required attendee, or optional attendee) is clearly shown along with the user name. The attendees list 1021 and the scheduled attendees list 1022 are updated by the output unit 403 each time the attendance status acquisition unit 404 acquires update information for the scheduled attendees list. That is, even if the user does not perform an update operation, the attendees list 1021 and the scheduled attendees list 1022 in which the latest update information is reflected are displayed.

The exit button 1006 is operated by a user in a case where the user is exiting the online meeting that the user is attending. In a case where the exit button 1006 is operated by the user, the input unit 402 accepts the operation to exit the online meeting, generates an exit request, and transmits the exit request from the transmission/reception unit 401 to the server 120. Upon acquiring a response (acceptance) from the server 120 to the exit request, the output unit 403 closes the meeting screen 1000.

Note that, even during the preparation time period prior to the start time of an online meeting, if the user of the user terminal 110 has entered the online meeting room of the relevant online meeting, the meeting screen 1000 of the online meeting is displayed on the display unit 210 of the user terminal 110. The term “enter the room” means that the user is accessing the URL of the online meeting room and the status of the user is “attending”. The description will now return to the flowchart of FIG. 9.

In S902, the determination unit 405 of the user terminal 110 determines whether or not a required attendee is attending. Specifically, the determination unit 405 refers to the scheduled attendees list 700 or update information therefor acquired in S901, and determines whether or not the category of a user whose attendance status has changed from “not attending” to “attending” is a required attendee. In a case where the attendance status of a required attendee has changed to “attending”, the determination unit 405 determines that the required attendee is attending, and the process proceeds to S903. If the result of the determination in S902 is “No”, the flowchart ends.

In S903, the determination unit 405 of the user terminal 110 determines whether or not all of the required attendees are attending. Specifically, the determination unit 405 refers to the scheduled attendees list 700 or update information therefor acquired in S901, and checks whether or not “not attending” is included among the attendance statuses of the scheduled attendees whose category is “required attendee”. If “not attending” is not included in the attendance statuses of the scheduled attendees whose category is “required attendee”, the determination unit 405 determines that all of the required attendees are attending, and the process proceeds to S904. Otherwise, that is, in a case where “not attending” is included in the attendance statuses of the scheduled attendees whose category is “required attendee”, the determination unit 405 determines that not all of the required attendees are attending, and the process proceeds to S905.

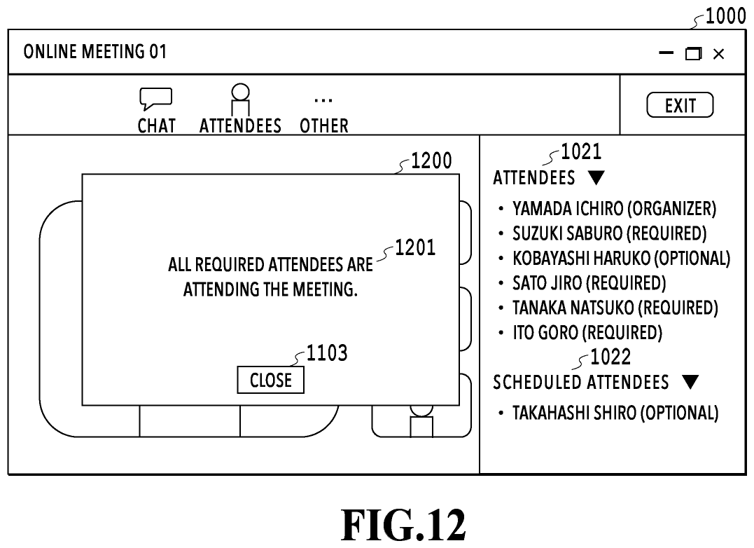

In S904, the notification unit 406 generates display data for a notification screen (attendance completion notification screen 1200 illustrated in FIG. 12) which includes a message indicating that all required attendees are attending. The notification unit 406 outputs the generated display data to the output unit 403.

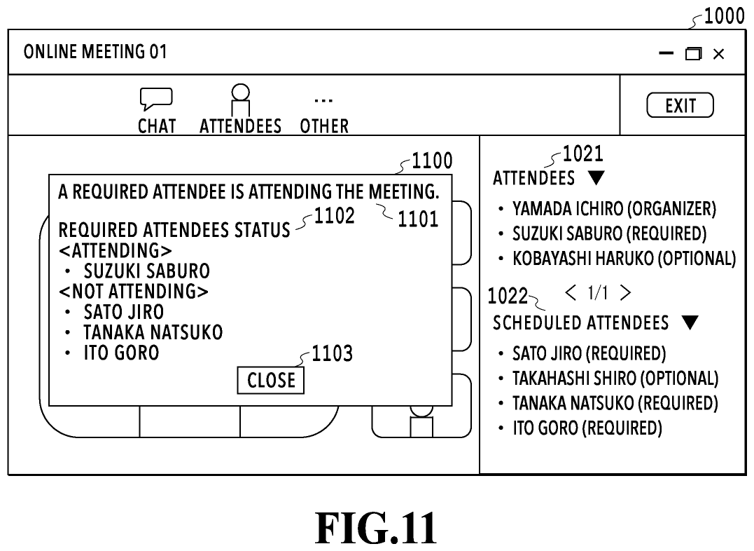

In S905, the notification unit 406 generates display data for a notification screen (attendance notification screen 1100 illustrated in FIG. 11) which includes a message indicating that a required attendee is attending, and the attendance statuses of the required attendees. The notification unit 406 outputs the generated display data to the output unit 403. After executing S904 or S905, the process proceeds to S906.

In S906, the output unit 403 determines whether or not a pop-up screen (attendance notification screen 1100 or attendance completion notification screen 1200) is already being displayed over the meeting screen 1000. If a pop-up screen is not being displayed, the process proceeds to S907. Otherwise, the process proceeds to S908.

In S907, the output unit 403 displays the display data generated in S904 or S905 on the display unit 210 as a pop-up screen.

In S908, the output unit 403 updates the pop-up screen that is already being displayed to the display data generated in S904 or S905. That is, the output unit 403 updates the display contents of the pop-up screen. In a case where the processing in S907 or S908 ends, the present flowchart ends.

FIG. 11 is a view illustrating an example of the attendance notification screen 1100 displayed in a pop-up window of the user terminal 110. In a case where the attendance status of a scheduled attendee who is set as a required attendee for the online meeting is “attending”, the attendance notification screen 1100 is displayed superimposed on (in front of) the meeting screen 1000. As illustrated in FIG. 11, an attendance message 1101, attendance statuses of required attendees 1102, and a close button 1103 are displayed on the attendance notification screen 1100.

The attendance message 1101 is a text message that indicates that a user who has been set as a required attendee is attending the online meeting, such as “A required attendee is attending the online meeting”. The attendance statuses of required attendees 1102 is generated based on the attendance statuses of the required attendees in the scheduled attendees list 700 stored in the RAM 203 at the time point at which the determination in S902 is made. In the attendance statuses of required attendees 1102, the attendance statuses of the required attendees are displayed as a list which is separated into <Attending> and <Not Attending>. The close button 1103 is a button that is operated to cancel (delete) the pop-up display of the attendance notification screen 1100.

Note that the output unit 403 also updates the display contents of the attendees list 1021 and the scheduled attendees list 1022 of the meeting screen 1000 that is being displayed underneath (behind) the attendance notification screen 1100 to the latest information.

FIG. 12 is a view illustrating an example of the attendance completion notification screen 1200 that is displayed in a pop-up window on the user terminal 110. In a case where all of the scheduled attendees who are set as required attendees for the online meeting are attending, the attendance completion notification screen 1200 is displayed superimposed on (in front of) the meeting screen 1000. As illustrated in FIG. 12, an attendance completion message 1201 and a close button 1103 are displayed on the attendance completion notification screen 1200.

The attendance completion message 1201 is a text message indicating that all of the users who are set as required attendees are attending the online meeting, such as “All required attendees are attending the online meeting.” The close button 1103 is a button that is operated to cancel (delete) the pop-up display of the attendance completion notification screen 1200.

As illustrated in FIG. 12, the contents of the attendees list 1021 and the scheduled attendees list 1022 are also updated in the information region 1020 of the meeting screen 1000 that is being displayed underneath (behind) the attendance completion notification screen 1200. For example, in FIG. 11, Yamada Ichiro (organizer), Suzuki Saburo (required), and Kobayashi Haruko (optional) are displayed in the attendees list 1021. Further, Sato Jiro (required), Takahashi Shiro (optional), Tanaka Natsuko (required), and Ito Goro (required) are displayed in the scheduled attendees list 1022. Among the aforementioned scheduled attendees, in a case where Sato Jiro (required), Tanaka Natsuko (required), and Ito Goro (required) who are three people who are required attendees then join the online meeting and the attendance status of each of these required attendees is updated to “attending”, the contents of the scheduled attendees list 1022 is updated as illustrated in FIG. 12. In other words, the names of the three people Sato Jiro (required), Tanaka Natsuko (required), and Ito Goro (required) are added to the attendees list 1021, and are deleted from the scheduled attendees list 1022.

The attendance notification screen 1100 and the attendance completion notification screen 1200 may be displayed on the user terminals 110 of all attendees of the online meeting, or may be displayed only on the user terminal 110 of a specific user, such as the organizer of the online meeting. Hereinafter, the organizer of the online meeting or a specific user designated as a facilitator or the like is referred to as “an organizer or the like”. In the latter case, after the processing in S901, the CPU 201 determines whether or not the user of the user terminal 110 is an organizer or the like of the relevant online meeting, and if the user is an organizer or the like, the CPU 201 executes the processing in S902 to S908. If the user is not an organizer or the like, the CPU 201 does not execute the processing in S902 to S908. In addition, a configuration may be adopted so that either one of the attendance notification screen 1100 and the attendance completion notification screen 1200 is displayed on the user terminal 110 of all the attendees of the online meeting. Alternatively, a configuration may be adopted so that either one of the attendance notification screen 1100 and the attendance completion notification screen 1200 is displayed on only the user terminal 110 of a user who is an organizer or the like of the online meeting. For example, a configuration may be adopted so that the attendance notification screen 1100 is displayed on only the user terminal of an organizer or the like, and the attendance completion notification screen 1200 is displayed on the user terminals of all the attendees.

Further, in the examples illustrated in FIG. 11 and FIG. 12, the notification unit 406 provides notifications relating to the attendance statuses of required attendees by displaying the attendance notification screen 1100 and the attendance completion notification screen 1200 in a pop-up window on top of (in front of) the meeting screen 1000. However, the form of notification is not limited to a pop-up display. For example, the attendance message 1101 and the attendance statuses of required attendees 1102 included in the attendance notification screen 1100 may be displayed in the information region 1020 of the meeting screen 1000. Further, the attendance completion message 1201 included in the attendance completion notification screen 1200 may be displayed in the information region 1020 of the meeting screen 1000. Alternatively, the notification unit 406 may output the text of the attendance message 1101 and the attendance completion message 1201 as audio output. Further, a configuration may be adopted in which the attendance message 1101 and the attendance completion message 1201 are notified as chat information using the chat function of the online meeting tool, or are sent to the email address of the organizer or the like or to the email addresses of the scheduled attendees.

As described above, in the online meeting system 1 of the present embodiment, a fact that a required attendee at an online meeting is attending the online meeting, and a fact that all required attendees are attending are immediately notified during the online meeting. Therefore, it is easy for an organizer or the like of the online meeting to confirm the attendance status of required attendees, thus allowing the organizer or the like to smoothly proceed with the online meeting. In particular, this is favorable in a case where the timing for starting the online meeting is conditioned on the attendance of all required attendees or on the attendance of a specific required attendee. Further, in a case where a required attendee attends the online meeting, the attendance status of the required attendee is updated in real time by the server 120, and the updated attendance status is shared with the user terminals 110 of the attendees of the online meeting from the server 120. It is thus possible for the user terminals 110 to provide an attendance notification with respect to a required attendee and an attendance completion notification with respect to all required attendees in real time. Furthermore, on the attendance notification screen 1100, the attendance statuses of required attendees are displayed separately as attending and not attending, and therefore the attendance statuses can be displayed in a manner that makes it easy to ascertain which required attendees are attending and to recognize what the attendance rate (non-attendance rate) is.

Note that, in the above first embodiment, in S901, information regarding the attendance status of each scheduled attendee, as illustrated in FIG. 7, is acquired from the server 120. In other words, information showing the participation information for a plurality of users invited to the online meeting is received from the server 120 that provides the online meeting. The information showing the participation information may be information showing the attendance status of each user as illustrated in FIG. 7, or may be information showing that all required attendees are participating in the online meeting. After it has been determined in the server 120 that all required attendees are participating, information showing that all required attendees are participating may be transmitted from the server 120 to the user terminals 110. In such case, the determinations in S902 and S903 are not made, and the processing in S904 is performed based on the fact that the information in question has been received.

Further, in the above first embodiment, whether or not all “required attendees” are participating in the online meeting is determined in S902 and S903. Then, based on the fact that all of the “required attendees” are participating in the online meeting, a message indicating that all of the “required attendees” are participating is displayed in S904. However, the present disclosure is not limited to this configuration. For example, based on the fact that all of the plurality of users scheduled to attend the online meeting are participating in the online meeting, a notification indicating that all of the plurality of users scheduled to attend the online meeting are participating in the online meeting may be issued. In such case, in S902, it is determined whether or not scheduled attendees that also include optional attendees and not only required attendees are attending. Further, in S903, it is determined whether or not all of the scheduled attendees including the optional attendees and not only the required attendees are attending. With regard to the specific determination method, the same processing as described above with respect to S902 and S903 is performed, except that “required attendee” in the above description of S902 and S903 is replaced with “scheduled attendee”.

Note that, the “scheduled attendees” include a user who is the organizer of the online meeting and who invited a plurality of users which are other scheduled attendees, as well as the plurality of users invited to the online meeting by the aforementioned user.

Although in the above first embodiment, the attendance completion notification is displayed in the form of a pop-up display, the form of displaying the attendance completion notification is not limited thereto. In the first embodiment, a new pop-up screen is displayed on top of the meeting screen 1000, and a notification is displayed within the pop-up screen. However, the present disclosure is not limited to this example, and for example a configuration may be adopted in which a pop-up notification showing the attendance completion notification is displayed at a predetermined position on the display unit of the user terminal 110. For example, the pop-up notification may be displayed at the lower right part of the display unit of the user terminal 110. It suffices that the configuration adopted provides, separately from the attendees list 1021 and the scheduled attendees list 1022, a notification which shows the users who were invited to the online meeting and that all of the invited users are participating. For example, a configuration may be adopted that, at an arbitrary position on the meeting screen 1000, displays a message which shows the users who were invited to the online meeting and that all of the invited users are participating. Further, a configuration may be adopted which provides an audio notification of the names of the users who were invited to the online meeting as well as the fact that all of the invited users are participating. To ensure that the users who are participating in the meeting can recognize the notification, the notification is displayed within the meeting screen 1000 or on a pop-up screen superimposed on the meeting screen 1000.

Although in the above first embodiment a message that “A required attendee is attending the online meeting” is notified, the present disclosure is not limited thereto. For example, the name of a required attendee who is not yet in attendance may be notified. Further, the name of a scheduled attendee who is not yet in attendance may be notified.

### Second Embodiment

In the first embodiment, an example was provided in which the organizer or the like of an online meeting determines whether or not it is appropriate to start the online meeting based on whether or not all of the required attendees are attending. However, criteria for determining whether or not to start an online meeting are not limited to this example. For example, in the case of a meeting between groups, it is conceivable that a situation may arise where it is appropriate to start the online meeting as long as at least one person from each group is in attendance, even if not all of the required attendees are in attendance. In the second embodiment a configuration is adopted so that, even in such cases, the organizer or the like can easily determine the timing at which to start the online meeting. Therefore, in a case where notifying the attendance of required attendees, the online meeting tool 400 indicates the attendance statuses of required attendees for each group.

Note that, in the second embodiment, the hardware configuration and the functional configuration of the user terminal 110 and the server 120 of the online meeting system 1 are the same as in the first embodiment. Hereunder, respective components that are the same as in the first embodiment are assigned the same reference numerals as in the first embodiment, and the description will focus on the points in which the second embodiment differs from the first embodiment.

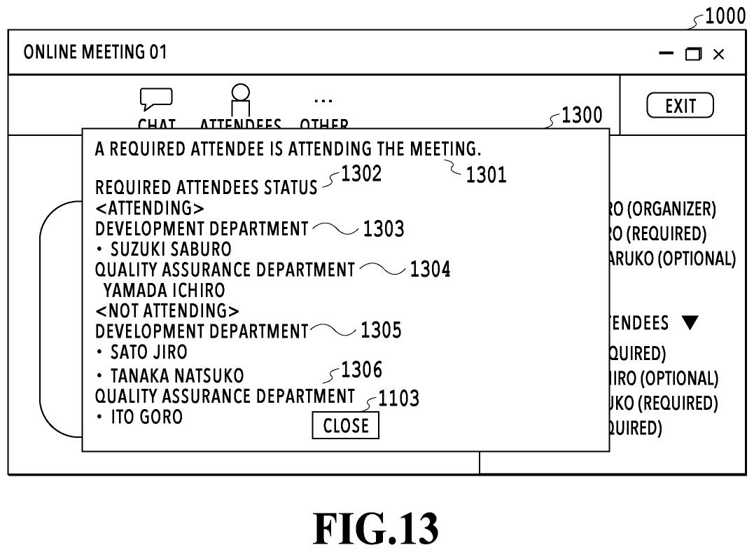

FIG. 13 is a view illustrating an example of an attendance notification screen 1300 displayed in a pop-up window in front of the meeting screen 1000 of the user terminal 110 in the second embodiment. Similarly to the first embodiment, the attendance notification screen 1300 is displayed in a case where the attendance status of a scheduled attendee who is set as a required attendee at the online meeting has been updated from “not attending” to “attending”. Note that in FIG. 13, each part that is the same as in the attendance notification screen 1100 of the first embodiment illustrated in FIG. 11 is assigned the same reference numeral as in the first embodiment.

As illustrated in FIG. 13, an attendance message 1301, attendance statuses of required attendees 1302, and a close button 1103 are displayed on the attendance notification screen 1300.

Similarly to the attendance message 1101 of the attendance notification screen 1100 of the first embodiment, the attendance message 1301 is a text message indicating that a user who has been set as a required attendee is attending the online meeting. The close button 1103 is also the same as the close button 1103 of the attendance notification screen 1100 of the first embodiment.

In the attendance statuses of required attendees 1302, the attendance statuses of the required attendees are displayed as a list in which the attendance statuses are separated into <Attending> and <Not Attending>, and are further separated by group. Specifically, among the required attendees whose attendance status is <Attending>, users belonging to the “Development Department” and users belonging to the “Quality Assurance Department” are displayed separately for each department (group). Likewise, with respect to the attendance status <Not Attending>, among the required attendees who are not in attendance, users belonging to the “Development Department” and users belonging to the “Quality Assurance Department” are displayed separately for each department (group). Note that, information regarding the groups which users belong to is managed as the user information 500 in the user information database 471 of the server 120. In this way, the attendance statuses of required attendees are displayed by department, and thus the attendees and non-attendees from each department are displayed in an easily viewable format.

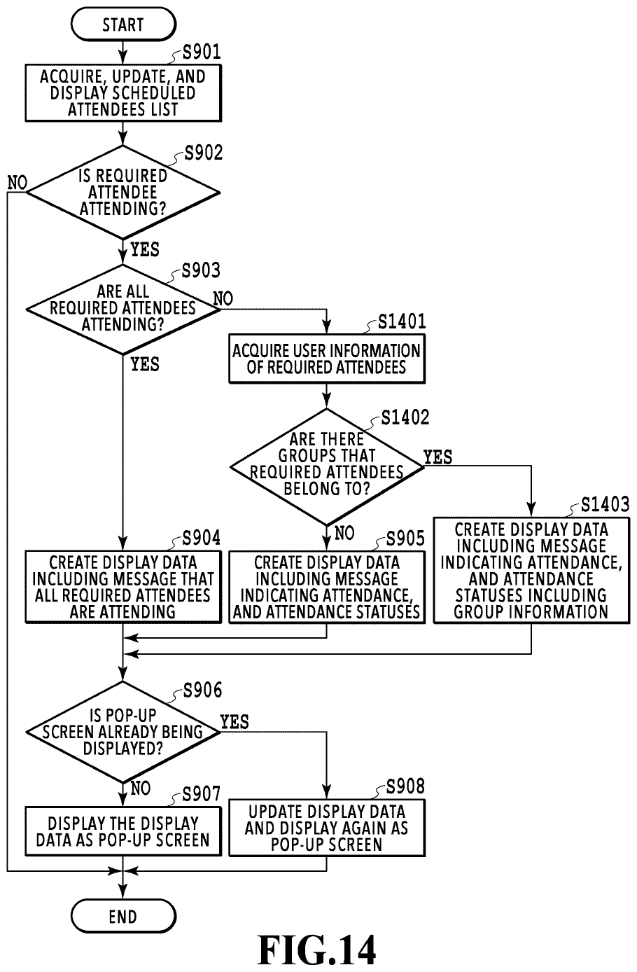

Next, processing that the user terminals 110 of the attendees of an online meeting execute in the second embodiment is described with reference to FIG. 14. FIG. 14 is a flowchart illustrating the flow of processing relating to updating and notification of an attendance status for an online meeting. The processing illustrated in the flowchart of FIG. 14 is described in a program of the online meeting tool 400. The program is called by the CPU 201 of the user terminal 110, loaded in the RAM 203, and executed by the CPU 201. After the time when the user can enter the online meeting room of the online meeting has arrived and the user performs an operation to attend the online meeting, the CPU 201 of the user terminal 110 accesses the online meeting room specified by the URL of the online meeting and requests to attend the online meeting. In a case where a response to the attendance request is received from the server 120, the processing of the flowchart shown in FIG. 14 is started.

In FIG. 14, processing that is the same as in the flowchart of FIG. 9 is assigned the same step number as in FIG. 9. In comparison to FIG. 9, the processing in S1401 to S1403 has been added to the flowchart of FIG. 14. Hereunder, the description will focus on the points that are different from the flowchart of FIG. 9.

The processing in S901 to S902 is the same as the processing in S901 to S902 in the flowchart of FIG. 9.

In S903, the determination unit 405 of the user terminal 110 determines whether or not all of the required attendees are attending. Specifically, the determination unit 405 refers to the scheduled attendees list 700 or update information therefor acquired in S901, and checks whether or not “not attending” is included among the attendance statuses of the scheduled attendees whose category is “required attendee”. If “not attending” is not included in the attendance statuses of the scheduled attendees whose category is “required attendee”, the determination unit 405 determines that all of the required attendees are attending, and the process proceeds to S904. Otherwise, that is, in a case where “not attending” is included in the attendance statuses of the scheduled attendees whose category is “required attendee”, the determination unit 405 determines that not all of the required attendees are attending, and the process proceeds to S1401.

In S1401, the attendance status acquisition unit 404 sends a request to acquire user information of required attendees to the server 120. Here, the term “user information” means user information that includes group information that shows which groups the users belong to. In the example of the second embodiment, the group information is the department to which the user belongs (development department or quality assurance department), and is registered in advance in association with the user ID as the user information 500. The attendance status acquisition unit 404 acquires the user information including group information of the required attendees from the server 120. Thereafter, the process proceeds to S1402.

In S1402, the determination unit 405 refers to the user information of the required attendees acquired in S1401, and determines whether or not there is a required attendee who belongs to a group. If there is a required attendee who belongs to a group, the process proceeds to S1403. If there is no required attendee who belongs to a group, the process proceeds to S905.

In S1403, the notification unit 406 creates display data (attendance notification screen 1300) that displays a message indicating that required attendees are attending, and the attendance statuses of the required attendees for each group. Thereafter, the process proceeds to S906.

The processing in S904 to S906 is the same as the processing in S904 to S906 in the flowchart of FIG. 9.

As described above, in the second embodiment, in a case where required attendees of an online meeting belong to groups, the attendance statuses of the required attendees are displayed for each group the required attendees belong to on the attendance notification screen 1300. Therefore, in a case where information regarding groups is required as a criterion for determining time to start an online meeting, the organizer or the like of the online meeting can easily determine the timing at which to start the online meeting, thus allowing the organizer or the like to smoothly proceed with the online meeting.

### Third Embodiment

According to the third embodiment, it is possible to accurately notify the attendance statuses of required attendees even in a case where there are absentees among the scheduled attendees. That is, in the processing described in the first and second embodiments, in a case where determining whether all required attendees are in attendance, it is also determined whether or not there are required attendees for whom it is known in advance will be absent. Further, absentees among the required attendees are displayed on the attendance completion notification screen.

Note that, in the third embodiment, the hardware configuration and the functional configuration of the user terminal 110 and the server 120 of the online meeting system 1 are the same as in the first embodiment. Hereunder, respective components that are the same as in the first embodiment are assigned the same reference numerals as in the first embodiment, and the description will focus on the points in which the third embodiment differs from the first embodiment.

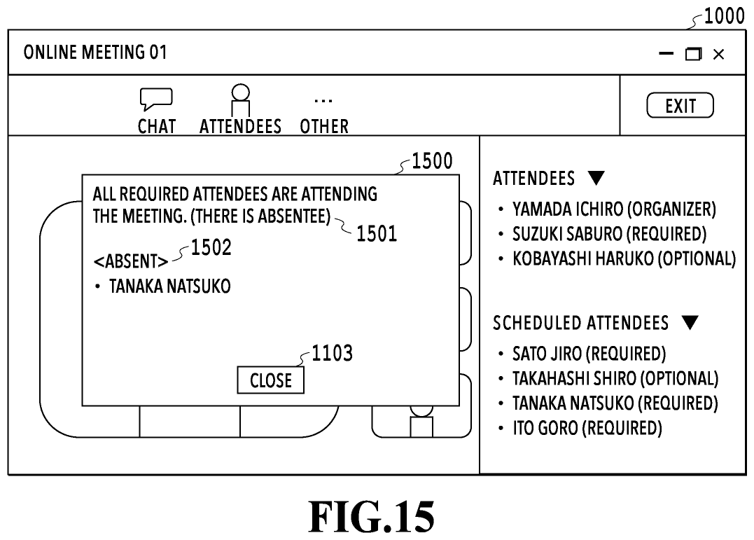

FIG. 15 is a view illustrating an example of an attendance completion notification screen 1500 that is displayed in a pop-up window over (in front of) the meeting screen 1000 of the user terminal 110 in the third embodiment. An attendance completion notification message 1501 and an absentee list 1502 are displayed on the attendance completion notification screen 1500. Further, whether there are any absentees is also clearly indicated on the attendance completion notification screen 1501. Note that in FIG. 15, each part that is the same as in the attendance notification screen 1100 of the first embodiment illustrated in FIG. 11 is assigned the same reference numeral as in the first embodiment.

In a case where a scheduled attendee who is designated as a required attendee wishes to be absent, the scheduled attendee transmits an absence request to the server 120 in response to an invitation to the online meeting that is transmitted in advance from the server 120 of the online meeting system 1. Although it is preferable that the absence request is transmitted before the start time of the online meeting, the absence request may also be transmitted after the start time has passed. In the scheduled attendees list 700, the meeting information management unit 480 of the server 120 updates the attendance status of the scheduled attendee who transmitted the absence request from “not attending” to “absent”, by performing the processing in S807 to S809 in FIG. 8. The updated scheduled attendees list 700 is shared with the user terminals 110 of the attendees of the online meeting in question.

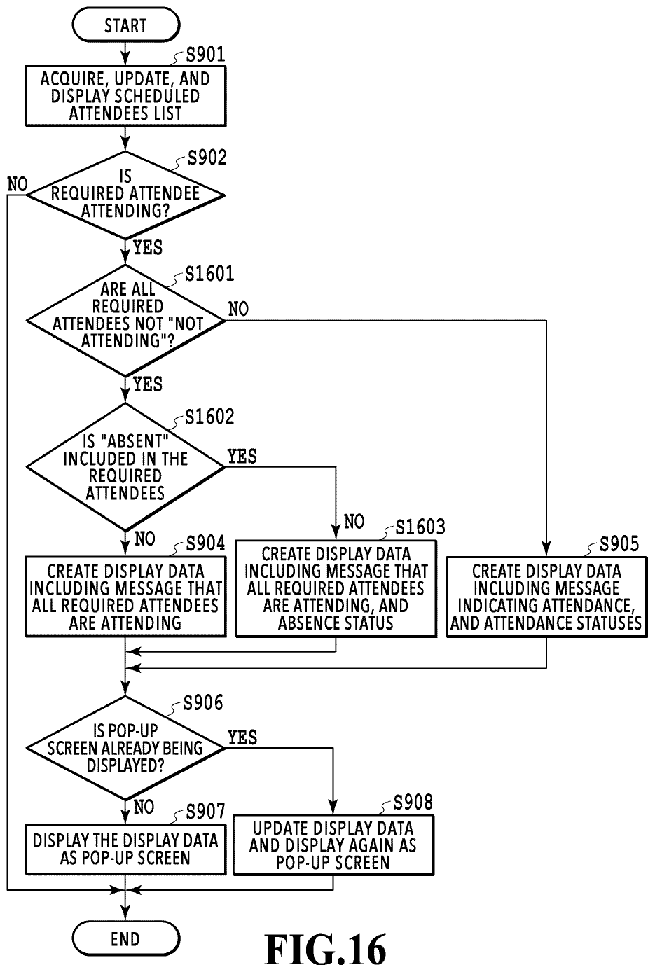

Next, processing that the user terminals 110 of the attendees of an online meeting execute in the third embodiment is described with reference to FIG. 16. FIG. 16 is a flowchart illustrating the flow of processing relating to updating and notification of attendance statuses for an online meeting. The processing illustrated in the flowchart of FIG. 16 is described in a program of the online meeting tool 400. The program is called by the CPU 201 of the user terminal 110, loaded in the RAM 203, and executed by the CPU 201. After the time when the user can enter the online meeting room of the online meeting has arrived and the user performs an operation to attend the online meeting, the CPU 201 of the user terminal 110 accesses the online meeting room specified by the URL of the online meeting and requests to attend the online meeting. In a case where a response to the attendance request is received from the server 120, the processing of the flowchart shown in FIG. 16 is started.

In FIG. 16, processing that is the same as in the flowchart of FIG. 9 is assigned the same step number as in FIG. 9. In comparison to FIG. 9, the processing in S1601 to S1603 has been added to the flowchart of FIG. 16. The processing in S1601 is processing that is substituted for the processing in S903 in the flowchart of FIG. 9. Hereunder, the description will focus on the points that are different from the flowchart of FIG. 9.

The processing in S901 to S902 is the same as the processing in S901 to S902 in the flowchart of FIG. 9. Note that, in S902, if the determination unit 405 of the user terminal 110 determines that a required attendee is attending the online meeting, the process proceeds to S1601, and if it is determined that the required attendee is not attending, the flowchart is ended.

In S1601, the determination unit 405 of the user terminal 110 determines whether or not any of the required attendees is “not attending”. Specifically, the determination unit 405 refers to the scheduled attendees list 700 or update information therefor acquired in S901, and checks whether or not “not attending” is included among the attendance statuses of the scheduled attendees whose category is “required attendee”. If “not attending” is not included in the attendance statuses of the scheduled attendees whose category is “required attendee”, the determination unit 405 determines that all of the required attendees are attending, and the process proceeds to S1602. If any of the required attendees is “not attending”, the process proceeds to S905.

In S1602, the determination unit 405 of the user terminal 110 determines whether or not an absentee is included among the required attendees. Specifically, the determination unit 405 refers to the scheduled attendees list 700 or update information therefor acquired in S901, and determines whether or not there is a user whose attendance status is “absent” among the scheduled attendees whose category is “required attendee”. If there is a user whose attendance status is “absent” among the scheduled attendees whose category is “required attendee”, the process proceeds to S1603. If not, the process proceeds to S904.

In S1603, the notification unit 406 generates display data for the attendance completion notification screen 1500 that includes a message indicating that all required attendees are attending except for absentees, and the absence status. As the absence status, for example, the user name of any required attendee whose attendance status has been updated to “absent” is displayed as the absentee list 1502. After the processing in S1603, S904, or S905 is completed, the process proceeds to S906.

The processing in S904 to S908 is the same as the processing in S904 to S908 of FIG. 9.

As described above, in the third embodiment, in a case where all required attendees except for required attendees whose attendance status is set to “absent” are attending the online meeting, the attendance completion notification screen 1500 is displayed. Therefore, even in a case where an absentee is included in the required attendees, the organizer or the like of the online meeting can determine the timing at which to start the online meeting, thus allowing the organizer or the like to smoothly proceed with the online meeting. Furthermore, because the absentee list 1502 showing required attendees who are absent is displayed on the attendance completion notification screen 1500, the organizer or the like can know in detail the absence status of required attendees.

### Fourth Embodiment

In the fourth embodiment, in the processing described in the first to third embodiments, if a required attendee exits an online meeting midway through the online meeting, the exit of the required attendee is notified.

Note that, in the fourth embodiment, the hardware configuration and the functional configuration of the user terminal 110 and the server 120 of the online meeting system 1 are the same as in the first embodiment. Hereunder, respective components that are the same as in the first embodiment are assigned the same reference numerals as in the first embodiment, and the description will focus on the points in which the fourth embodiment differs from the first embodiment.

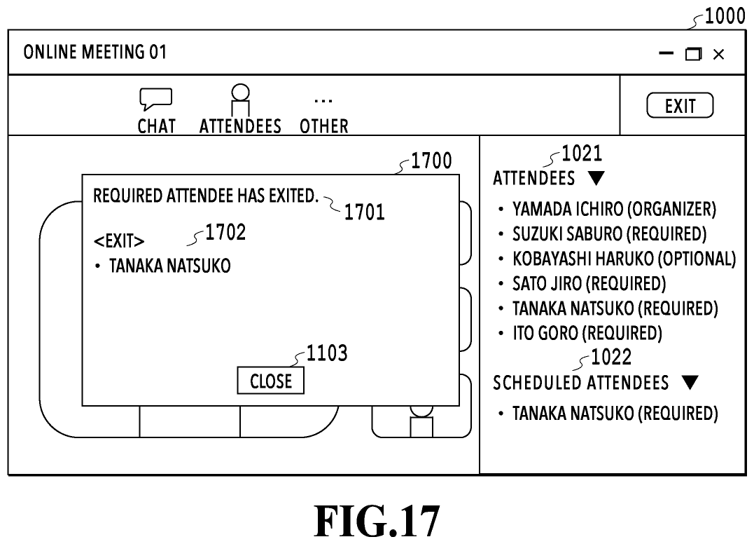

FIG. 17 is a view illustrating an example of an exit notification screen 1700 that is displayed in a pop-up window over (in front of) the meeting screen 1000 of the user terminal 110 in the fourth embodiment. An exited persons list 1702 that is a list of users who have exited the online meeting among the required attendees is displayed on the exit notification screen 1700. Further, the fact a person exited the online meeting is also clearly indicated as an exit notification message 1701. Note that in FIG. 17, each part that is the same as in the attendance notification screen 1100 of the first embodiment illustrated in FIG. 11 is assigned the same reference numeral as in the first embodiment.

In a case where a user exits from an online meeting, the user presses an exit button 1006 on the meeting screen 1000. Upon the exit button 1006 being pressed, the input unit 402 of the online meeting tool 400 accepts the instruction to exit which was input by the user, and transmits the exit request to the server 120 from the transmission/reception unit 401. A user ID and a meeting ID are included in the exit request. The meeting information management unit 480 of the server 120 executes the processing in S804 to S806 in FIG. 8 to call up the scheduled attendees list 700 corresponding to the meeting ID included in the exit request and update the attendance status of the scheduled attendee corresponding to the user ID included in the exit request from “attending” to “not attending”. The updated scheduled attendees list 700 is shared in real time with the user terminals 110 of the attendees attending the online meeting in question.

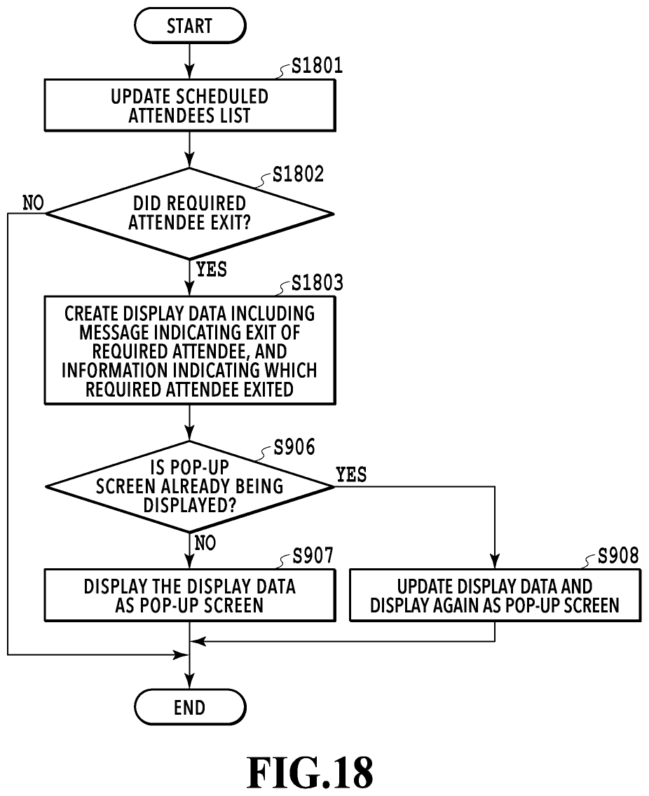

Next, processing that the user terminals 110 of the attendees of an online meeting execute in the fourth embodiment is described with reference to FIG. 18. FIG. 18 is a flowchart illustrating the flow of processing relating to updating and notification of attendance statuses for an online meeting. The processing illustrated in the flowchart of FIG. 18 is described in a program of the online meeting tool 400. The program is called by the CPU 201 of the user terminal 110, loaded in the RAM 203, and executed by the CPU 201. The flowchart illustrated in FIG. 18 is started in a case where the user terminal 110 receives update information for the scheduled attendees list 700 from the server 120. Note that the processing illustrated in FIG. 18 may be executed in the user terminals 110 of all attendees of the online meeting or may be executed in only the user terminal 110 of the organizer or the like.

In S1801, the attendance status acquisition unit 404 of the user terminal 110 updates the scheduled attendees list 700 stored in the RAM 203 based on update information acquired from the server 120. Based on the attendance statuses after the updating, the output unit 403 updates the display of the attendees list 1021 and the scheduled attendees list 1022 that are displayed in the information region 1020 of the meeting screen 1000. Thereafter, the process proceeds to S1802.

In S1802, the determination unit 405 determines whether or not a required attendee exited from the online meeting. Specifically, the determination unit 405 determines whether or not the category of a user whose attendance status changed from “attending” to “not attending” in the update information acquired in S1801 is a required attendee. If the category of a user whose attendance status changed from “attending” to “not attending” is a required attendee, the determination unit 405 determines that a required attendee has exited, and the process proceeds to S1803. If not, the present flowchart is ended.

In S1803, the notification unit 406 generates display data (exit notification screen 1700) that shows a message indicating that a required attendee has exited, and the exit status of the required attendee. As the exit status, for example, the user names of required attendees whose attendance status was updated from “attending” to “not attending” is displayed as the exited persons list 1702. Thereafter, the process proceeds to S906. The processing in S906 to S908 is the same as in S906 to S908 of FIG. 9.

As described above, according to the fourth embodiment, if a required attendee exits an online meeting midway through the online meeting, the exit of the required attendee is notified. Therefore, the organizer or the like of the online meeting can easily ascertain that a required attendee has exited the online meeting. Further, since the exited persons list 1702 is displayed on the exit notification screen 1700, the organizer or the like of the online meeting can ascertain which required attendees have exited, which can be useful for proceeding with the online meeting.

### Fifth Embodiment

In the first to fourth embodiments, the user terminal 110 acquires the scheduled attendees list 700 managed by the server 120, and stores the acquired scheduled attendees list 700 on the RAM 203 of the user terminal 110. The user terminal 110 also acquires update information for the scheduled attendees list 700 from the server 120. Further, determination of the attendance statuses of required attendees, and generation of notification information such as attendance notifications and an attendance completion notification for required attendees as well as generation of display data are also performed on the user terminal 110 side. However, the server 120 may perform these processes. As the fifth embodiment, an example will be described in which the server 120 acquires the attendance statuses of scheduled attendees, determines the attendance statuses of required attendees, generates notification information such as attendance notifications and an attendance completion notification for required attendees, and generates display data.

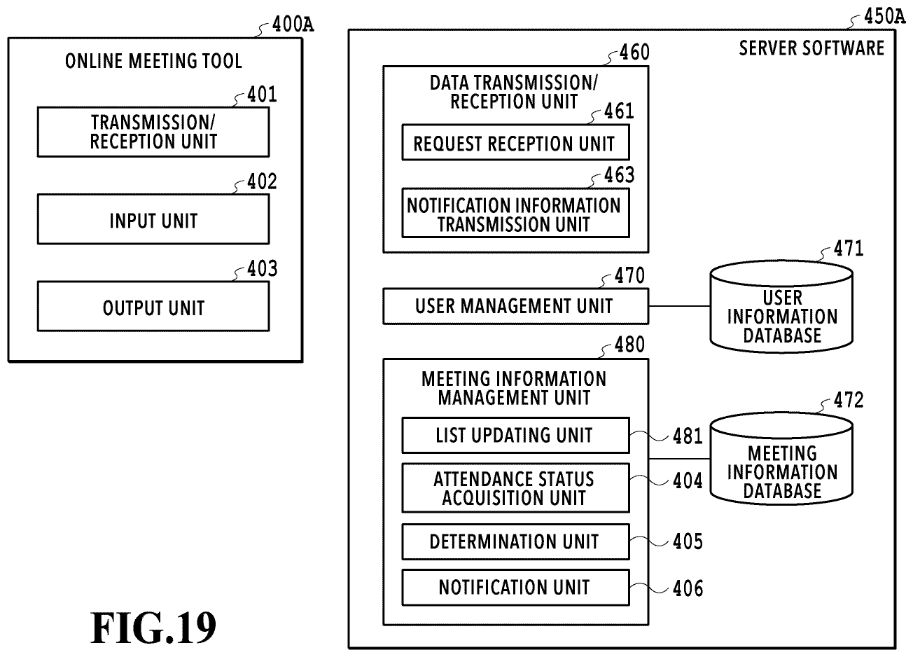

FIG. 19 is a block diagram illustrating the software configuration of an online meeting system in the fifth embodiment. As illustrated in FIG. 19, the online meeting system includes an online meeting tool 400 A and server software 450 A.

The online meeting tool 400A is an application program which the CPU 201 of the user terminal 110 executes. In the present specification, the online meeting tool 400A is stored in any one of the RAM 203, the storage 204, and the ROM 202 of the user terminal 110. The server software 450A is an application program which the CPU 301 of the server 120 executes. In the present specification, the server software 450A is stored in any storage device among the RAM 303, the storage 304, and the ROM 302 of the server 120, and is executed by the CPU 301.

### (Online Meeting Tool)

As illustrated in FIG. 19, the online meeting tool 400A has the transmission/reception unit 401, the input unit 402, and the output unit 403. The CPU 201 of the user terminal 110 calls a program of the online meeting tool 400A stored in the storage 204, and the CPU 201 executes processing in accordance with the program. By this means, the CPU 201 causes the user terminal 110 to function as the transmission/reception unit 401, the input unit 402, and the output unit 403.

### (Server Software)

As illustrated in FIG. 19, the server software 450A has the data transmission/reception unit 460, the user management unit 470, the meeting information management unit 480, the user information database 471, and the meeting information database 472. The data transmission/reception unit 460 includes the request reception unit 461 and a notification information transmission unit 463. The meeting information management unit 480 includes the list updating unit 481, the attendance status acquisition unit 404, the determination unit 405, and the notification unit 406. The CPU 301 of the server 120 calls a program of the server software 450A stored in the storage 304, and the CPU 301 executes processing in accordance with the program to thereby cause the server 120 to function as each component illustrated in FIG. 19.

The difference from the configuration illustrated in FIG. 4 is that the attendance status acquisition unit 404, the determination unit 405, and the notification unit 406 are provided in the meeting information management unit 480 of the server software 450A. Although the functions and processing contents of each component are approximately the same as in the first embodiment, points in which the fifth embodiment differs from the first embodiment are described below.

In the fifth embodiment the transmission/reception unit 401 of the online meeting tool 400A carries out communication with the server 120 via the communication line 101, and transmits and receives various kinds of data including audio data, imaging data, display data, and meeting information for an online meeting. In the first embodiment, the transmission/reception unit 401 of the user terminal 110 (online meeting tool 400A) receives the scheduled attendees list 700 and update information therefor from the server 120. In the fifth embodiment, the transmission/reception unit 401 does not receive or transmit the scheduled attendees list 700 and update information therefor. Instead, the transmission/reception unit 401 receives display data for a screen including notification information relating to the attendance of required attendees from the server 120 (the notification information transmission unit 463).

Similarly to the first embodiment, the output unit 403 displays a notification screen including a meeting screen that is a UI screen of the online meeting and notification information on the display unit 210 of the user terminal 110. Display data for the screen including the notification information is generated by the attendance status acquisition unit 404, the determination unit 405, and the notification unit 406 of the server 120.

The attendance status acquisition unit 404 acquires the attendance statuses of the scheduled attendees which include required attendees (first users) whose attendance at the online meeting is required and optional attendees (second users) whose attendance at the online meeting is optional from the list updating unit 481. The attendance statuses are managed as the scheduled attendees list 700 in the meeting information management unit 480 of the server 120. In a case where there is a change in an attendance status such as a change from “not attending” to “attending”, the list updating unit 481 passes the scheduled attendees list 700 or update information for the scheduled attendees list 700 to the attendance status acquisition unit 404.

The determination unit 405 determines whether or not a required attendee is attending the online meeting based on the attendance status of the required attendee among the attendance statuses which the attendance status acquisition unit 404 acquired. Specifically, the determination unit 405 determines whether or not the attendance status of the required attendee has changed to “attending”. Further, the determination unit 405 determines whether or not all required attendees are attending the online meeting based on the attendance statuses of the required attendees among the attendance statuses which the attendance status acquisition unit 404 acquired. Specifically, the determination unit 405 determines whether or not the attendance statuses of all of the required attendees have changed to “attending”. The determination unit 405 passes the determination result to the notification unit 406.

The notification unit 406 generates notification information based on the determination result determined by the determination unit 405 based on the attendance statuses of the required attendees that the attendance status acquisition unit 404 acquired. In a case where it was determined by the determination unit 405 that a required attendee is attending the online meeting, the notification unit 406 generates notification information to the effect that the required attendee is attending the online meeting. In a case where it is determined by the determination unit 405 that all of the required attendees are attending the online meeting, the notification unit 406 generates notification information to the effect that all of the required attendees are attending the online meeting. The notification unit 406 generates screen data (screen data for the attendance notification screen or attendance completion notification screen or the like) that includes the generated notification information, and immediately passes the screen data to the data transmission/reception unit 460.

In a case where the notification information transmission unit 463 of the data transmission/reception unit 460 acquires display data including the notification information generated by the notification unit 406, the notification information transmission unit 463 immediately transmits the display data to a predetermined notification destination. The notification destination may be the user terminals 110 of all attendees of the online meeting, or may be limited to the user terminal 110 of the organizer or the like.

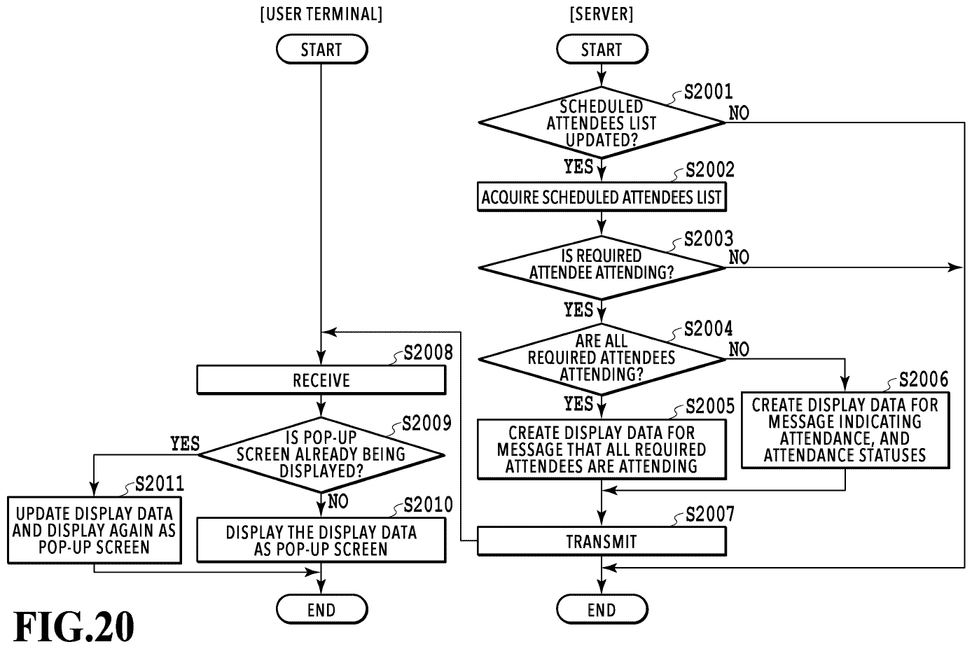

FIG. 20 is a sequence diagram illustrating the flow of processing performed in the online meeting system 1 of the fifth embodiment. The processing in S2001 to S2007 is described in a program of the server software 450A, and is executed by the CPU 301 of the server 120. The processing in S2008 to S2011 is described in a program of the online meeting tool 400A, and is executed by the CPU 201 of the user terminal 110. After startup, the server 120 starts the processing in S2001. After starting up the online meeting tool 400A, the user terminal 110 enters the online meeting room (transmits an attendance request), and acquires display data for the meeting screen from the server 120. In a case where the meeting screen is displayed, the processing in S2007 is started. In the following description, the symbol “S” represents “step”.

In S2001, the meeting information management unit 480 of the server 120 determines whether or not the scheduled attendees list 700 has been updated. Updating of the scheduled attendees list 700 is performed, for example, in a case where an attendance request which was transmitted from the user terminal 110 was received (S802 in FIG. 8), in a case where an exit request was received (S805), or a case where an absence request was received (S808). If the scheduled attendees list 700 has been updated, the process proceeds to S2002. If not, the present flowchart is ended.

In S2002, the attendance status acquisition unit 404 of the server 120 acquires the updated scheduled attendees list 700.

In S2003, the determination unit 405 of the server 120 determines whether or not a required attendee is attending. Specifically, the determination unit 405 refers to the scheduled attendees list 700 acquired in S2002, and checks whether or not a user whose attendance status changed from “not attending” to “attending” is a required attendee. If the determination unit 405 determines that a required attendee is attending, the process proceeds to S2004, and if not, the flowchart is ended.

In S2004, the determination unit 405 of the user terminal 110 determines whether or not all of the required attendees are attending. Specifically, the determination unit 405 refers to the scheduled attendees list 700 acquired in S2002, and checks whether or not “not attending” is included among the attendance statuses of the scheduled attendees whose category is “required attendee”. If “not attending” is not included in the attendance statuses of the scheduled attendees whose category is “required attendee”, the determination unit 405 determines that all of the required attendees are attending, and the process proceeds to S2005. Otherwise, that is, in a case where “not attending” is included in the attendance statuses of the scheduled attendees whose category is “required attendee”, the determination unit 405 determines that not all of the required attendees are attending, and the process proceeds to S2006.

In S2005, the notification unit 406 generates display data (attendance completion notification screen 1200 illustrated in FIG. 12) which includes a message indicating that all required attendees are attending.

In S2006, the notification unit 406 generates display data (attendance notification screen 1100) which includes a message indicating that a required attendee is attending, and the attendance statuses of the required attendees. After executing S2005 or S2006, the process proceeds to S2007.

In S2007, the notification unit 406 sends the display data for the attendance completion notification screen 1200 generated in S2005 or the display data for the attendance notification screen 1100 generated in S2006 to the notification information transmission unit 463. The notification information transmission unit 463 transmits the display data for the attendance completion notification screen 1200 or the display data for the attendance notification screen 1100 to the user terminals 110 set as the notification destination, via the network I/F 307. Thereafter, the processing of the server software 450A is ended.

In S2008, the transmission/reception unit 401 of the user terminal 110 receives the display data for the attendance completion notification screen 1200 or the display data for the attendance notification screen 1100 from the server 120. The transmission/reception unit 401 outputs the received display data to the output unit 403.

In S2009, the output unit 403 determines whether or not a pop-up screen is already being displayed over the UI screen (meeting screen). If a pop-up screen is not being displayed, the process proceeds to S2010. Otherwise, the process proceeds to S2011.

In S2010, based on the display data received in S2008, the output unit 403 displays the attendance notification screen 1100 or the attendance completion notification screen 1200 as a pop-up screen on the display unit 210.

In S2011, the output unit 403 updates the pop-up screen that is already being displayed, based on the display data received in S2008. That is, the output unit 403 updates the display contents of the pop-up screen.

In a case where the processing in S2010 or S2011 ends, the user terminal 110 ends the processing of the present flowchart.

As described above, acquisition and determination of attendance statuses, generation of notification information regarding attendance statuses, and generation of display data for a screen that includes notification information are performed on the server 120 side, and the user terminal 110 receives the display data including notification information generated on the server 120 side and updates the screen that includes the notification information. By this means, screen transitions similar to those in the first embodiment can be performed according to the attendance statuses of required attendees. Since the attendance statuses are managed on the server 120 side, the processing load on the user terminal 110 is reduced. Note that, similarly with respect to messages relating to the absence or exit of a required attendee that are described in the second to fourth embodiments, a configuration may be adopted in which, on the server 120 side, the attendance statuses are managed, display data including notification information is generated, and the display data is transmitted to user terminals for display in a pop-up window.

As described above, according to the online meeting system described in the above embodiments, notification information for required attendees whose attendance at an online meeting is required can be generated and notified to a predetermined notification destination. This can be useful for proceeding with an online meeting for which required or optional attendance has been specified, thus improving the convenience of the online meeting system.

Note that, although in the above embodiments, in a case where all required attendees are attending the online meeting, information to that effect is notified, there are also cases where an attendance condition is set for an online meeting to be valid, such as that two-thirds of the required attendees or 10 or more of the required attendees are attending. In such a case, a configuration may be adopted so that in a case where the predetermined attendance condition is satisfied, a notification to that effect is sent.

Whilst preferred embodiments of the present disclosure have been described above with reference to the appended drawings, the present disclosure is not limited to the above examples. The display contents of the meeting screens or the notification screens displayed in a pop-up window, and the processing procedures in the flowcharts and the like are examples, and the present disclosure is not limited to the examples described in the embodiments. It is evident that those skilled in the art can derive various modifications or revised examples within the scope of the disclosed technical ideas, and it should be understood that these modifications or revised examples also rightfully belong to the technical scope of the present disclosure.

The present disclosure can also be implemented by a process of supplying a program for implementing one or more functions of the above-described embodiments to a system or apparatus via a network or storage medium, and causing one or more processors in a computer of the system or apparatus to read out and execute the program. In addition, the present disclosure can also be implemented by a circuit (for example, an ASIC) for implementing one or more functions.

According to the information processing apparatus of the present disclosure, it is possible to perform notification that provides greater convenience to attendees of an online meeting.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220342, filed Dec. 16, 2024 and No. 2025-183645, filed Oct. 30, 2025, which are hereby incorporated by reference herein in their entirety.

What is claimed is:

1. A storage medium that stores a computer program that executes a control method for controlling an information processing apparatus,
wherein the control method:
displays a screen of an online meeting that is provided by a server on a display unit;
receives, from the server, information indicating participation statuses with respect to the online meeting of a plurality of users who are scheduled to participate in the online meeting; and
based on a determination being made that all of the plurality of users are participating in the online meeting based on the information that is received, further displays an object which had not been displayed on the screen and which is an object that indicates that all of the plurality of users are participating in the online meeting.

2. The storage medium according to claim 1, wherein:
the object is a pop-up notification that is displayed over the screen.

3. The storage medium according to claim 1, wherein:
the object is a pop-up notification that is displayed at a predetermined position on the display unit.

4. The storage medium according to claim 1, wherein:
the object is a message that is displayed within the screen.

5. The storage medium according to claim 1, wherein:
the information is received each time the participation statuses are updated, and
an object is immediately generated and notified based on the updated participation statuses.

6. The storage medium according to claim 1, wherein:
information indicating a participation status with respect to the online meeting of each of the plurality of users is displayed together with identification information of the plurality of users on the screen.

7. The storage medium according to claim 6, wherein:
the object is displayed on the display unit of the information processing device separately from the information indicating the participation status with respect to the online meeting of each of the plurality of users that is displayed on the screen.

8. The storage medium according to claim 6, wherein:
the identification information of the plurality of users is displayed in a format that distinguishes between identification information of users who are participating in the online meeting and identification information of users who are not participating in the online meeting.

9. The storage medium according to claim 6, wherein:
in a case where the plurality of users belong to groups, groups to which the plurality of users belong are displayed together with the identification information of the plurality of users.

10. The storage medium according to claim 9, wherein:
the identification information of the plurality of users is displayed in a format that distinguishes between identification information of users who are participating in the online meeting and identification information of users who are not participating in the online meeting, and is displayed for each group to which the plurality of users belong.

11. The storage medium according to claim 1, wherein:
in a case where a user who declined in advance to participate in the online meeting is included among the plurality of users, the object is displayed based on a determination being made that all of the plurality of users other than the user who declined are participating in the online meeting.

12. The storage medium according to claim 11, wherein:
the object includes identification information of the user who declined in advance to participate in the online meeting.

13. The storage medium according to claim 1, wherein:
the information is information indicating participation statuses with respect to the online meeting of the plurality of users including first users whose participation in the online meeting is required and second users whose participation in the online meeting is optional; and
based on a determination being made that all of the first users are participating in the online meeting based on the information, an object which had not been displayed on the screen and which is an object that indicates that all of the first users are participating in the online meeting is further displayed.

14. The storage medium according to claim 13, wherein:
in a case where the participation status of the first user changes from participating to not participating, third notification information indicating to the effect that the first user exited from the online meeting is notified.

15. A control method that:
displays a screen of an online meeting that is provided by a server on a display unit;
receives, from the server, information indicating participation statuses with respect to the online meeting of a plurality of users who are scheduled to participate in the online meeting; and
based on a determination being made that all of the plurality of users are participating in the online meeting based on the information that is received, further displays an object which had not been displayed on the screen and which is an object that indicates that all of the plurality of users are participating in the online meeting.

16. An information processing apparatus comprising:
at least one memory storing instructions; and
at least one processor executing the instructions to perform:
display a screen of an online meeting that is provided by a server on a display unit;
reception, from the server, information indicating participation statuses with respect to the online meeting of a plurality of users who are scheduled to participate in the online meeting; and
based on a determination being made that all of the plurality of users are participating in the online meeting based on the information that is received, further display an object which had not been displayed on the screen and which is an object that indicates that all of the plurality of users are participating in the online meeting.
